(19) United States
(12) Patent Application Publication
(10) Pub. No.: US 2024/0065271 A1
(43) Pub. Date: Feb. 29, 2024

(54) MIXTURES AND COMPOSITIONS COMPRISING FUSARICIDIN A, FUSARICIDIN B AND FUNGICIDES

(71) Applicant: BASF SE, Ludwigshafen (DE)

(72) Inventors: Reinhard Stierl, Limburgerhof (DE); Burghard Liebmann, Frederiksberg (DK); Lutz Brahm, Limburgerhof (DE)

(21) Appl. No.: 18/268,662

(22) PCT Filed: Dec. 13, 2021
(86) PCT No.: PCT/EP2021/085516

§ 371 Date: Jun. 21, 2023

(30) Foreign Application Priority Data
Dec. 23, 2020 (EP) 20216798.7

(51) Int. Cl. A01N 47/44; A01N 35/04; A01N 37/18; A01N 37/48; A01N 43/28; A01N 43/32; A01N 43/40; A01N 43/42; A01N 43/50; A01N 43/56; A01N 43/653; A01N 43/713; A01N 43/80; A01N 43/88; A01N 43/90; A01N 47/12; A01N 47/14; A01N 47/34; A01N 57/12; A01N 63/25; A01P 3/00

(52) U.S. Cl. CPC A01N 47/44; A01N 35/04; A01N 37/18; A01N 37/48; A01N 43/28; A01N 43/32; A01N 43/40; A01N 43/42; A01N 43/50; A01N 43/56; A01N 43/653; A01N 43/713; A01N 43/80; A01N 43/88; A01N 43/90; A01N 47/12; A01N 47/14; A01N 47/34; A01N 57/12; A01N 63/25; A01P 3/00

(57) ABSTRACT

The present invention relates to novel mixtures comprising, as active components, fusaricidin A and fusaricidin B, and at least one fungicide selected from the group comprising difenoconazole, spiraoxamine, fluxapyroxad, boscalid, fluindapyr, isoflucypram, inpyrfluxam, pydiflumetofen, pyrimethanil, fluoxastrobin, metyltetraprole, trifloxystrobin, cyazofamid, amisulbrom, zoxamide, cymoxanil, fluazinam, valifenalate, benthiavalicarb, iprovalicarb, mandipropamid, dimethomorph, fluopicolide, ametoctradin, oxathiapiprolin, pyriofenone, metrafenone, metiram, man-cozeb, dithianon, fosetyl and fosetyl-A1. The present invention also relates to a method of controlling or suppressing plant pathogens or preventing plant pathogen infections by applying such mixtures.

### FIELD OF THE INVENTION

The present invention relates to novel mixtures comprising, as active components, fusaricidin A and fusaricidin B, and at least one fungicide selected from the group comprising difenoconazole, spiroxamine, fluxapyroxad, boscalid, fluindapyr, isoflucypram, inpyrfluxam, pydiflumetofen, pyrimethanil, fluoxastrobin, metyltetraprole, trifloxystrobin, cyazofamid, amisulbrom, zoxamide, cymoxanil, fluazinam, valifenalate, benthiavalicarb, iprovalicarb, mandipropamid, dimethomorph, fluopicolide, ametoctradin, oxathiapiprolin, pyriofenone, metrafenone, metiram, mancozeb, dithianon, fosetyl and fosetyl-Al. The present invention also relates to a method of controlling or suppressing plant pathogens or preventing plant pathogen infections by applying such mixtures.

### BACKGROUND OF THE INVENTION

In the technical field of controlling phytopathogenic fungi affecting plants or crops it is well known to apply biopesticides. These biopesticides may or may not be combined with synthetic chemical pesticides of phytophatogenic fungi.

Biopesticides have been defined as a form of pesticides based on micro-organisms (bacteria, fungi, viruses, nematodes, etc.) or natural products (compounds or extracts from biological sources) (U.S. Environmental Protection Agency: http://www.epa.gov/pesticides/biopesticides/). Biopesticides are typically created by growing and concentrating naturally occurring organisms and/or their metabolites including bacteria and other microbes, fungi, viruses, nematodes, proteins, etc. They are often considered to be important components of integrated pest management (IPM) programmes, and have received much practical attention as substitutes to synthetic chemical pesticides.

For controlling phytopathogenic fungi several microbial pesticides comprising spore-forming bacteria such as Paenibacillus species have been described earlier, see e. g.

WO 1999/059412 discloses a Paenibacillus polymyxa strain PKB1 (bearing ATCC accession no. 202127) active against several phytopathogenic fungi.

WO 2011/069227 discloses a Paenibacillus polymyxa strain JB05-01-1 (bearing ATCC accession no. PTA-10436) having a highly inhibitory effect against pathogenic bacteria, pre-dominantly food-borne human pathogenic bacteria.

Another Paenibacillus polymyxa strain called AC-1 is known from “Biocontrol activity of Paenibacillus polymyxa AC-1 against Pseudomonas syringae and its interaction with Arabidopsis thaliana” 2016 Microbiological Research 185 DOI: 10.1016/j.micres.2016.01.004 and product Topseed from Green Biotech Co., Ltd. 45-70 Yadang-ri, Gyoha-Eup Paju Kyungki-Do, Korea (South) 413-830.

A further Paenibacillus polymyxa strain presumably called HY96-2 is known from Biocontrol Science and Technology 24 (4), 426-435 (2014) and shall be marketed under the name KangDiLeiDe by Shanghai Zeyuan Marine Biotechnology Co.,Ltd.

WO2016/154297 discloses mutants of Paenibacillus sp. strains including strains NRRL B-50972 and NRRL B-67129 and lipopeptides with structural similarity to fusaricidins called Paeniserines and Paeniprolixins.

WO2019/221988 discloses mutants of Paenibacillus sp., including strains NRRL B-67304, NRRL B-67306 and NRRL B-67615.

WO2020/181053 discloses Paenibacillus sp. strains. NRRL B-50374, NRRL B-67721, NRRL B-67723 and NRRL B-67724.

WO2019/155253 discloses Paenibacillus polymyxa strain VMC10/96.

WO2018/195603 discloses Paenibacillus sp. 10.6D and Paenibacillus sp. 9.4E.

Combinations of Paenibacillus strains, some of their metabolites, and synthetic chemical pesticides have been disclosed as well, see. e.g.:

WO2017/137351 discloses three different Paenibacillus strains, important metabolites of these strains and synergistic combinations of these strains and metabolites with synthetic chemical pesticides.

As used herein, the term Paenibacillus strain is identical to the term Paenibacillus sp. strain and means a bacterial strain form the genus Paenibacillus. The genus Paenibacillus includes all species Paenibacillus spp.

Paenibacillus is known to produce many antibiotic metabolites which are lipopeptides e.g. polymyxins, octapeptins, polypeptins, pelgipeptins and fusaricidins. Fusaricidins are a group of antibiotics isolated from Paenibacillus spp. from the class of cyclic lipodepsipeptides which often share the following structural features: a macrocyclic ring consisting of 6 amino acid residues, three of which are L-Thr, D-allo-Thr and D-Ala, as well as the 15-guanidino-3-hydroxypentadecanoic acid tail attached to the N-terminal L-Thr residue by an amide bond (ChemMedChem 7, 871-882, 2012; J. Microbiol. Meth. 85, 175-182, 2011, Table 1 herein). These compounds are cyclized by a lactone bridge between the N-terminal L-Thr hydroxyl group and the C-terminal D-Ala carbonyl group. The position of the amino acid residues within the depsipeptide cycle are usually numbered starting with the abovementioned L-Thr which itself also carries the GHPD chain and ending with the C-terminal D-Ala. Non-limiting examples of fusaricidins isolated from Paenibacillus are designated LI-F03, LI-F04, LI-F05, LI-F07 and LI-F08 (J. Antibiotics 40(11), 1506-1514, 1987; Heterocycles 53(7), 1533-1549, 2000; Peptides 32, 1917-1923, 2011) and fusaricidins A (also called LI-F04a), B (also called LI-F04b), C (also called LI-F03a) and D (also called LI-F03b) (J. Antibiotics 49(2), 129-135, 1996; J. Antibiotics 50(3), 220-228, 1997). The amino acid chain of a fusaricidin is not ribosomally generated but is generated by a non-ribosomal peptide synthetase. Structural formulae of known fusaricidins are shown in Table 1 (Biotechnol Lett. 34, 1327-1334, 2012; FIG. 1 therein). The compounds designated as LI-F03a, LI-F03b up to LI-F08a and LI-F08b and the fusaricidins of formulae I and I.1 as described herein are also referred to as fusaricidins LI-F03a, LI-F03b up to LI-F08a and LI-F08b due to their structure within the fusaricidin family (see e.g. Table 1).

Among isolated fusaricidin antibiotics, fusaricidin A has shown the most promising antimicrobial activity against a variety of clinically relevant fungi and gram-positive bacteria such a Staphylococcus aureus (MIC value range: 0.78-3.12 μg/ml) (ChemMedChem 7, 871-882, 2012). The synthesis of fusaricidin analogues that contain 12-guanidino-dodecanoic acid (12-GDA) or 12-amino-dodecanoic acid (12-ADA) instead of naturally occurring GHPD has been established but the replacement of GHPD by 12-ADA resulted in complete loss of the antimicrobial activity while the replacement of GHPD by 12-GDA retained antimicrobial activity (Tetrahedron Lett. 47, 8587-8590, 2006; ChemMedChem 7, 871-882, 2012).

TABLE 1
Structures of the fusaricidin family.

| Fusaricidin | X² | X³ | X⁵ |
|---|---|---|---|
| A (LI-F04a) | D-Val | L-Val | D-Asn |
| B (LI-F04b) | D-Val | L-Val | D-Gln |
| C (LI-F03a) | D-Val | L-Tyr | D-Asn |
| D (LI-F03b) | D-Val | L-Tyr | D-Gln |
| LI-F05a | D-Val | L-lle | D-Asn |
| LI-F05b | D-Val | L-Ile | D-Gln |
| LI-F06a | D-allo-lle | L-Val | D-Asn |
| LI-F06b | D-allo-lle | L-Val | D-Gln |
| LI-F07a | D-Val | L-Phe | D-Asn |
| LI-F07b | D-Val | L-Phe | D-Gln |
| LI-F08a | D-lle | L-allo-lle | D-Asn |
| LI-F08b | D-Ile | L-allo-lle | D-Gln |

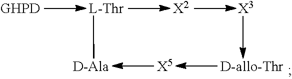

wherein an arrow defines a single (amide) bond either between the carbonyl moiety of GHPD and the amino group of L-Thr (L-threonine) or between the carbonyl group of one amino acid and the amino group of a neighboring amino acid, wherein the tip of the arrow indicates the attachment to the amino group of said amino acid L-Thr or of said neighboring amino acid; and
wherein the single line without an arrow head defines a single (ester) bond between the carbonyl group of D-Ala (D-alanine) and the hydroxyl group of L-Thr; and wherein GHPD is 15-guanidino-3-hydroxypentadecanoic acid.

Fusaricidins A, B, C and D are also reported to inhibit plant pathogenic fungi such as Fusarium oxysporum, Aspergillus niger, Aspergillus oryzae, and Penicillum thomii (J. Antibiotics β49(2), 129-135, 1996; J. Antibiotics 50(3), 220-228, 1997). Fusaricidins such as Li-F05, LI-F07 and LI-F08 have been found to have certain antifungal activity against various plant pathogenic fungi such as Fusarium moniliforme, F. oxysporum, F. roseum, Giberella fujkuroi, Helminthosporium sesamum and Penicillium expansum (J. Antibiotics 40(11), 1506-1514, 1987). Fusaricidins also have antibacterial activity to Gram-positive bacteria including Staphylococcus aureus (J. Antibiotics 49, 129-135, 1996; J. Antibiotics 50, 220-228, 1997). In addition, fusaricidins have antifungal activity against Leptosphaeria maculans which causes black root rot of canola (Can. J. Microbiol. 48, 159-169, 2002). Moreover, fusaricidins A and B and two related compounds thereof, wherein D-allo-Thr is bound via its hydroxyl group to an additional alanine using an ester bridge, produced by certain Paenibacillus strains were found to induce resistance reactions in cultured parsley cells and to inhibit growth of Fusarium oxysporum (WO 2006/016558; EP 1 788 074 A1).

WO 2007/086645 describes the fusaricidin synthetase enzyme and its encoding gene as isolated from Paenibacillus polymyxa strain E681 which enzyme is involved in the synthesis of fusaricidins A, B, C, D, LI-F03, LI-F04, LI-F05, LI-F07 and LI-F08.

In abovementioned WO 2016/020371 it was found that the whole culture broth, the culture medium and cell-free extracts of the Paenibacillus strains Lu16774, Lu17007 and Lu17015 show inhibitory activity inter alia against Alternaria spp., Botrytis cinerea and Phytophthora infestans. Bioactivity guided fractionation of organic extracts of these strains led to the isolation of fusaricidin-type compounds (herein referred to as fusaricidin 1A and 1 B) , the structure of which were elucidated by 1D- and 2D-NMR spectroscopy as well as mass spectrometry:

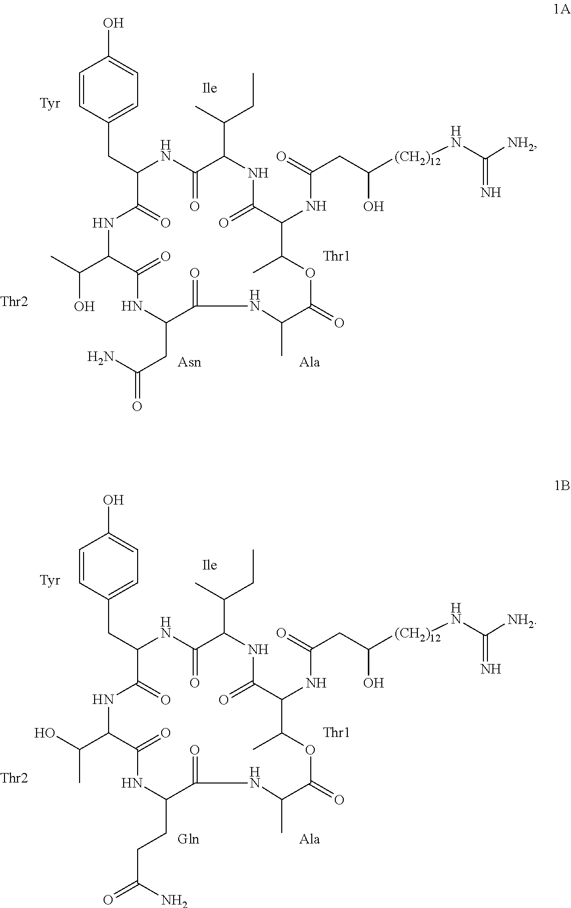

However, biopesticides under certain conditions can also have disadvantages, such as high specificity (requiring an exact identification of the pest/pathogen and the use of multiple products), slow speed of action (thus making them unsuitable if a pest outbreak is an immediate threat to a crop), variable efficacy due to the influences of various biotic and abiotic factors (since biopesticides are usually living organisms, which bring about pest/pathogen control by multiplying within the target insect pest/pathogen), and resistance development.

Practical agricultural experience has shown that the repeated and exclusive application of an individual active component in the control of harmful fungi or insects or other pests leads in many cases to a rapid selection of those fungus strains or pest isolates which have developed natural or adapted resistance against the active component in question. Effective control of these fungi or pests with the active component in question is then no longer possible.

To reduce the risk of the selection of resistant fungus strains or insect isolates, mixtures of different active components are nowadays conventionally employed for controlling harmful fungi or insects or other pests. By combining pestidically active compounds and/or biopesticides having different mechanisms of action, it is possible to ensure successful control over a relatively long period of time.

It is an object of the present invention overcome the abovementioned disadvantages and to provide, with a view to effective resistance management and effective control of phytopathogenic harmful fungi, insects or other pests or to effective plant growth regulation, at application rates which are as low as possible, compositions which, at a reduced total amount of active compounds applied, have improved activity against the harmful fungi or pests or improved plant growth regulating activity (synergistic mixtures) and a broadened activity spectrum, in particular for certain indications.

One typical problem arising in the field of pest control lies in the need to reduce the dosage rates of the active ingredient in order to reduce or avoid unfavorable environmental or toxicological effects whilst still allowing effective pest control. In regard to the instant invention the term pests embrace animal pests, and harmful fungi.

It was therefore an object of the present invention to provide pesticidal mixtures which solve the problems of reducing the dosage rate and/or enhancing the spectrum of activity and/or providing improved resistance management.

We have found that this object is achieved by the mixtures and compositions defined herein.

### DESCRIPTION OF THE INVENTION

One embodiment of the invention is a mixture, comprising as active components a component 1
a combination of fusaricidin A and fusaricidin B, wherein fusaricidin A and fusaricidin B have the general formula

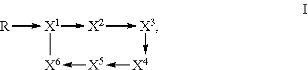

wherein
R is selected from 15-guanidino-3-hydroxypentadecanoic acid (GHPD) and 12-guanidinododecanoic acid (12-GDA);
X¹ is threonine;
X² is valine;
X³ is valine;
X⁴ is threonine;
X⁵ is selected from glutamine and asparagine;
X⁶ is alanine; and
wherein an arrow defines a single (amide) bond either between the carbonyl moiety of R and the amino group of the amino acid X¹ or between the carbonyl group of one amino acid and the amino group of a neighboring amino acid, wherein the tip of the arrow indicates the attachment to the amino group of said amino acid X¹ or of said neighboring amino acid; and
wherein the single line without an arrow head defines a single (ester) bond between the carbonyl group of X⁶ and the hydroxyl group of X¹ and
fusaricidin A has asparagine as X⁵ and
fusaricidin B has glutamine as X⁵ and
and comprising as component 2 difenoconazole, spiroxamine, fluxapyroxad, boscalid, fluindapyr, isoflucypram, inpyrfluxam, pydiflumetofen, pyrimethanil, fluoxastrobin, metyltetraprole, trifloxystrobin, cyazofamid, amisulbrom, zoxamide, cymoxanil, fluazinam, valifenalate, benthiavalicarb, iprovalicarb, man-dipropamid, dimethomorph, fluopicolide, ametoctradin, oxathiapiprolin, pyriofenone, metrafenone, metiram, mancozeb, dithianon, fosetyl or fosetyl-Al, preferably comprising as component 2 spiroxamine, boscalid, fluoxastrobin, metyltetraprole, trifloxystrobin, cyazofamid, amisulbrom, zoxamide, cymoxanil, fluazinam, valifenalate, benthiavalicarb, iprovalicarb, mandipropamid, fluopicolide, ametoctradin, oxathiapiprolin, pyriofenone, metrafenone, metiram, mancozeb, dithianon, fosetyl or fosetyl-aluminium (fosetyl-Al);
and wherein the mixture of component 1 and component 2 provides a synergistic fungicidal effect.

The term “synergistic effect” is understood to refer in particular to that defined by Colby's formula (Colby, S. R., “Calculating synergistic and antagonistic responses of herbicide combinations”, Weeds, 15, pp. 20-22, 1967).

The term “synergistic effect” is also understood to refer to that defined by application of the Tammes method, (Tammes, P. M. L., “Isoboles, a graphic representation of synergism in pesticides”, Nether!. J. Plant Pathol. 70, 1964).

The fungicide listed as component 2 are known in the art.

The combination of fusaricidin A and fusaricidin B (component 1) has preferably a ratio of fusaricidin A to fusaricidin B between 10:1 to 1:10, 9:1 to 1:9, 8:1 to 1:8, 7:1 to 1:7, 6:1 to 1:6, 5:1 to 1:5, 4:1 to 1:4, 3:1 to 1:3, 2:1 to 1:2, 9:5 to 5:9, 8:5 to 5:8, 7:5 to 5:7, 6:5 to 5:6, 11:10 to 10:11 or 1:1. In one embodiment the ratio of fusaricidin A to fusaricidin B is between 1:1, 10: 9, 10:8, 10:7, 10:6, 10:5, 10:4, 10:3, 10:2, and 10:1.

In a further embodiment the ratio of fusaricidin A to fusaricidin B is between 1:1, 9:10, 8:10, 7:10, 6:10, 5:10, 4:10, 3:10, 2:10, and 1:10.

The ratios defined herein are, if not stated otherwise, to be understood as ratios of weight to weight, meaning a ratio of 1:2 of compound A to compound B will translate to 1 gram of compound A to 2 grams of compound B, or 1 kilogram of compound A to 2 kilograms of compound B.

The combination of fusaricidin A and fusaricidin B can be present as compounds which have been isolated from the producing Paenibacillus strain or its culture broth. The term isolated refers to compounds which have been purified according to any conventional isolation or purification methodology known in the art including, but not limited to, treatment with a conventional resin (e. g., anion or cation exchange resin, non-ionic adsorption resin, etc.), treatment with a conventional adsorbent (e. g., activated charcoal, silicic acid, silica gel, cellulose, alumina, etc.), alteration of pH, solvent extraction (e. g., with a conventional solvent such as an alcohol, ethyl acetate, hexane and the like), distillation, dialysis, filtration, concentration, crystallization, recrystallization, pH adjustment, lyophilization and the like. For example the metabolites can be recovered from culture media by first removing the microorganisms. Methods designed for the isolation of fusaricidins, including fusaricidin A and B and similar compounds have been described in the prior art, e.g. WO2016/020371 and WO2016/154297.

But can also refer to the preparation of an cell-free extract comprising fusaricidin A and fusaricidin B. As used herein, “cell-free extract” refers to an extract of the vegetative cells, spores and/or the whole culture broth of a microorganism comprising fusaricidin A and fusaricidin B produced by the respective microorganism obtainable by methods known in the art such as solvent-based (e. g. organic solvents such as alcohols sometimes in combination with suitable salts). Suitable extraction methods for fusaricidin A and fusaricidin B are known in the art. The desired extract may be concentrated by conventional concentration techniques such as drying, evaporation, centrifugation or alike. Certain washing steps using organic solvents and/or water-based media may also be applied to the crude extract preferably prior to use.

Alternatively, the mixture of fusaricidin A and fusaricidin B can be present as a whole culture broth, comprising cells or spores of a microorganism, preferably of a Paenibacillus species, which produced fusaricidin A and fusaricidin B and/or has the capacity to produce fusaricidin A and fusaricidin B. As used herein, “whole culture broth” refers to a liquid culture of a microorganism containing vegetative cells and/or spores suspended in the culture medium

In a preferred embodiment, the mixture of fusaricidin A and fusaricidin B is present together with cells or spores of the microorganism, preferably of a Paenibacillus species, which produced fusaricidin A and fusaricidin B and/or has the capacity to produce fusaricidin A and fusaricidin B, wherein the cells or spores have been separated from the liquid culture medium used to grow the respective microorganism, preferably, having been washed and concentrated. Methods of concentration are well known to the skilled person, such methods, without excluding others, can be filtration or centrifugation. Centrifugation may be performed at temperatures of about 2 to 60° C., more preferably at temperatures of 4 to 60° C., for about 10 to 60 min, more preferably about 15 to 30 min, at about 5,000 to 20,000×g (more preferably at about 15,000×g). Usually, the separated cells or spores are not separated to purity, but only to a fraction which comprise the cells or spores accompanied with other solid components of the liquid culture medium used to grow the respective microorganism (fermentation solids).

Accordingly, in one embodiment, the combination of fusaricidin A and fusaricidin B are present in combination with cells or spores of one or more Paenibacillus strains still producing or having produced the fusaricidin A and fusaricidin B of the combination.

These Paenibacillus strains can be any Paenibacillus strains having the capacity to produce fusaricidin A and fusaricidin B. Such Paenibacillus strains can be identified by testing for the production of fusaricidin A and fusaricidin B. Sufficient guidance production conditions of fusaricidin A and/or fusaricidin B and testing methods for the presence of fusaricidin A and/or fusaricidin B are well known in the art e.g. in the documents mentioned in the “Background of the Invention” section herein, e.g. WO2016/020371. A preselection of suitable strains can be performed by bioinformatic searches for strains comprising genes with similarity to the fusaricidin synthase gene described in WO2007/086645.

Paenibacillus strains producing fusaricidin A and/or fusaricidin B can be found in many Paenibacillus species, for example, but not excluding others the Paenibacillus species: Paenibacillus polymyxa, Paenibacillus epiphyticus, Paenibacillus peoriae, Paenibacillus terrae, Paenibacillus jamilae and Paenibacillus kribbensis.

Exemplary Paenibacillus strains, which have the capacity to produce fusaricidin A and/or fusaricidin B are: P. polymyxa strain PKB1, P. polymyxa strain JB05-01-1, P. polymyxa strain AC-1, P. polymyxa strain HY96-2, Paenibacillus sp. strains NRRL B-50972, NRRL B-67129, NRRL B-67304, NRRL B-67306 and NRRL B-67615, NRRL B-50374, NRRL B-67721, NRRL B-67723, NRRL B-67724, P. polymyxa strain VMC10/96, Paenibacillus sp. strain 10.6D and Paenibacillus sp. strain 9.4E, Paenibacillus sp. strains Lu16774, Lu17007 and Lu17015, P. polymyxa strain M1, P. polymyxa strain SC2 and P. polymyxa strain Sb3-1 and P. polymyxa strain E681.

As used herein, “strain” refers to a bacterial isolate or a group of isolates exhibiting phenotypic and/or genotypic traits belonging to the same lineage, distinct from those of other isolates or strains of the same species. The Paenibacillus strains are usually present as an isolated culture. An “isolated culture” or “substantially purified culture” refers to a culture of the strains of the invention that does not include significant amounts of other materials which normally are found in natural habitat in which the strain grows and/or from which the strain normally may be obtained. Consequently, such “isolated culture” or “substantially purified culture” is at least 60% free, preferably at least 75% free, and more preferably at least 90% free, even more preferably at least 95% free, and most preferably at least 99% free from other materials which normally are found in natural habitat in which the strain grows and/or from which the strain normally may be obtained. Such an “isolated culture” or “substantially purified culture” does normally not include any other microorganism in quantities sufficient to interfere with the replication of the strain having produced or producing fusaricidin A and fusaricidin B.

The Paenibacillus strains as used in the mixtures of the invention can be cultivated continuously or discontinuously in the batch process or in the fed batch or repeated fed batch process. A review of known methods of cultivation will be found in the textbook by Chmiel (Bioprozesstechnik 1. Einführung in die Bioverfahrenstechnik (Gustav Fischer Verlag, Stuttgart, 1991)) or in the textbook by Storhas (Bioreaktoren and periphere Einrichtungen (Vieweg Verlag, Braunschweig/Wiesbaden, 1994)).

The medium that is to be used for cultivation of the Paenibacillus strain must satisfy the requirements of the particular strains in an appropriate manner. Descriptions of culture media for various microorganisms are given in the handbook “Manual of Methods for General Bacteriology” of the American Society for Bacteriology (Washington D.C., USA, 1981). Further suitable media are disclosed in the art, e.g. in the documents cited herein.

Preferably, the Paenibacillus strain has antifungal activity against at least two of the plant pathogen selected from the group consisting of Alternaria solani, Botrytis cinerea, Phytophthora infestans and Sclerotinia sclerotiorum.

Preferably the Paenibacillus strain present in the mixture produces further fusaricidins described in the art, like fusaricidin C (LI-F03a), fusaricidin D (LI-F03b), or the fusaricidins LI-F05a, LI-F05b, LI-F06a, LI-F06b, LI-F07a, LI-F07b, LI-F08a and LI-F08b or further antifungal compounds, like antifungal enzymes or peptides. In a further embodiment, the fusaricidin A and fusaricidin B had been isolated from a Paenibacillus strain together with other fusaricidins or further antifungal compounds.

WO2016/020371 describes the fusaricidins fusaricidin 1A having the formula 1A and fusaricidin 1B, having the formula 1B, which are produced by Paenibacillus species, for example, but no excluding others, the strains Lu16774, Lu17007 and Lu17015 and strains derived therefrom.

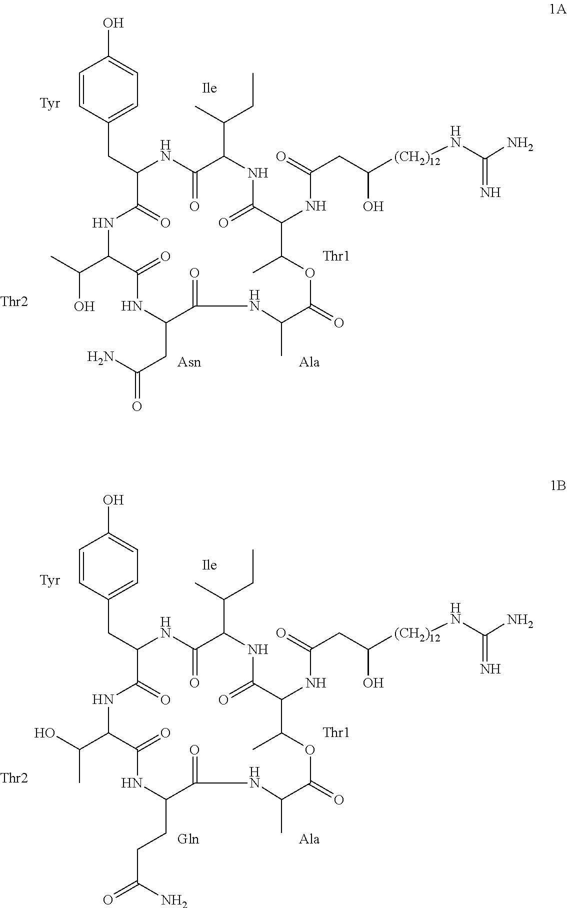

WO2016/020371 describes further, that fusaricidin 1A and fusaricidin 1B have a high activity against phytopathogenic fungi, such as, but not excluding others, Alternaria solani. Botrytis cinerea, Pyricularia oryzae, Leptosphaeria nodorum and Zymoseptoria tritici

Accordingly, a further preferred embodiment comprises a mixture comprising component 1 and component 2 described in the embodiments above, and further comprising fusaricidin 1A or fusaricidin 1B or both.

WO2016/154297 discloses fusaricidin-like compounds called paeniserines and paeniprolixins, which are produced by Paenibacillus species, in particular by the strains NRRL B-50972, NRRL B-67129 and strains derived therefrom. The following paeniserines and paeniprolixins are described in WO2016/154297: paeniserine A1, paeniserine A2, paeniserine A3, paeniserine A4, paeniserine B1, paeniserine B2, paeniserine B3, paeniserine B4, paeniserine C1, paeniserine C2 and paeniserine C3, paeniprolixin A1, paeniprolixin A2, paeniprolixin B1, paeniprolixin B2, paeniprolixin Cl, paeniprolixin Dl, paeniprolixin El, paeniprolixin E2, paeniprolixin F1, paeniprolixin F2, paeniprolixin G1, and paeniprolixin G2.

The same disclosures describes that a mixture of fusaricidin A and paeniserine A1 and a mixture of fusaricidin A and paeniprolixin C1 have improved activity against phytopathogens fungi, such as, but not excluding others, Alternaria solani.

Accordingly, another preferred embodiment is a mixture comprising component 1 and component 2 described in the embodiments above, and further comprising at least one paeniserine or paeniprolixine, preferably comprising paeniserine A1 or paeniprolixin C1 or both.

The mixture comprising component 1 and component 2 has synergistic fungicidal effects against phytopathogenic fungi, in particular against at least one of Colletotrichum orbiculare, Sclerotinia sclerotiorum, Botrytis cinerea Alternaria solani, Leptosphaeria nodorum, Zymoseptoria tritici and Pyricularia oryzae.

In one preferred embodiment the mixture comprising component 1 and component 2 has synergistic fungicidal effects against Colletotrichum orbiculare and comprises spiroxamine, metyltetraprole, pyrimethanil, zoxamide, pyriofenone or dithianon as component 2.

In one preferred embodiment the mixture comprising component 1 and component 2 has synergistic fungicidal effects against Sclerotinia sclerotiorum and comprises trifloxystrobin, zoxamide, mandipropamid or dithianon as component 2.

In one preferred embodiment the mixture comprising component 1 and component 2 has synergistic fungicidal effects against Botrytis cinerea and comprises trifloxystrobin, zoxamide, mandipropamid, oxathiapiprolin or pyriofenone as component 2.

In one preferred embodiment the mixture comprising component 1 and component 2 has synergistic fungicidal effects against Pyricularia oryzae and comprises difenoconazole, spiroxamine, boscalid, pyrimethanil, fluoxastrobin, metyltetraprole, cyazofamid, amisulbrom, zoxamide, cymoxanil, fluazinam, valifenalate, benthiavalicarb, iprovalicarb, mandipropamid, fluopicolide, pyriofenone, metrafenone, metiram, mancozeb, fosetyl or fosetyl-Al as component 2.

The mixtures described in the embodiments above preferably comprise a further fungicide as component 3. Preferably, the fungicide of component 3 is also present in the mixture in amounts which provide a synergistic fungicidal effect with a mixture of fusaricidin A, fusaricidin B and/or at least one of fusaricidin 1A, fusaricidin 1B, one or more paeniserines, one or more paeniprolixins and/or the fungicide of component 2.

Preferred the fungicide used as component 3 is selected from the following groups a) to m):
a) difenoconazole, prothioconazol, mefentrifluconazol, metconazole, triticonazol, difenoconazol, iriadimenol, prochloraz, tebuconazol, epoxiconazol, ipconazol, metalaxyl-M, mefenoxam, spiroxamine, penflufen, isofetamid, bixafen, fluxapyroxad, boscalid, benzovindiflupyr, fluopyram, penthiopyrad, sedaxan, fluindapyr, isoflucypram, inpyrfluxam, pydiflumetofen, cyprodinil, pyrimethanil, fluoxastrobin, azoxystrobin, trifloxystrobin, yraclostrobin, metyltetraprole, dimoxystrobin, picarbutrazox, fludioxonil, thiophanate, thiophanate-methyl, thiabendazol, silthiofam, picoxystrobin, orysastrobin, fenhexamid, fenpyrazamine, cyazofamid, amisulbrom, zoxamide, ethaboxam, cymoxanil, propamocarb, fluazinam, triazoxide, valifenalate, benthiavalicarb, iprovalicarb, mandipropamid, dimethomorph, fluopicolide, ametoctradin, oxathiapiprolin, fluoxapiprolin, pyriofenone, metrafenone, sulphur, metiram, mancozeb, thiram, folpet, dithianon, fosetyl and fosetyl-Al, preferably from difenoconazole, prothioconazol, mefentrifluconazol, metconazole, triticonazol, difenoconazol, triadimenol, prochloraz, tebuconazol, epoxiconazol, ipconazol, metalaxyl-M, mefenoxam, spiroxamine, fludioxonil, penflufen, bixafen, fluxapyroxad, boscalid, benzovindiflupyr, fluopyram, penthiopyrad, sedaxan, pyrimethanil, fluoxastrobin, metyltetraprole, azoxystrobin, trifloxystrobin, pyraclostrobin, dimoxystrobin, picoxystrobin, orysastrobin, cyazofamid, amisulbrom, thiabendazole, thiophanate-methyl, zoxamide, ethaboxam, cymoxanil, picarbutrazox, fluazinam, valifenalate, benthiavalicarb, iprovalicarb, mandipropamid, dimethomorph, fluopicolide, ametoctradin, silthiofam oxathiapiprolin, pyriofenone, metrafenone, metiram, mancozeb, thiram, dithianon, fosetyl or fosetyl-aluminium, more preferred from difenoconazole, prothioconazole, mefentrifluconazole, metconazole, triticonazole, difenoconazole, triadimenole, prochloraz, tebuconazole, epoxiconazole, ipconazole, metalaxyl-M, penflufene, bixafene, fluxapyroxad, benzovindiflupyr, fluopyram, penthiopyrad, sedaxane, pyrimethanil, azoxystrobin, trifloxystrobin, pyraclostrobin, dimoxystrobin, picoxystrobin, orysastrobin, ethaboxam, dimethomorph, thiram, picarbutrazox, fludioxonil, thiophanate, thiophanatemethyl, thiabendazole and silthiofam,
b) azoxystrobin, coumethoxystrobin, coumoxystrobin, dimoxystrobin, enestroburin, fenaminstrobin, fenoxystrobin/flufenoxystrobin, fluoxastrobin, metyltetraprole, kresoximmethyl, mandestrobin, metominostrobin, orysastrobin, picoxystrobin, pyraclostrobin, pyrametostrobin, pyraoxystrobin, trifloxystrobin, 2 (2-(3-(2,6-di-chlorophenyl)-1-methyl-allylideneaminooxymethyl)-phenyl)-2 methoxyimino-N methyl-acetamide, pyribencarb, triclopyricarb/chlorodincarb, famoxadone, fenamidone, methyl-N-[2-[(1,4-dimethyl-5 phenyl-pyrazol-3-yl)oxylmethyl]phenyl]-N-methoxy-carbamate, metyltetraprole, (Z,2E) 5 [1-(2,4-dichloro¬phenyl)pyrazol-3-yl]-oxy-2-methoxyimino-N,3-dimethyl-pent-3-en-amide, (Z,2E) 5 [1 (4-chlorophenyl)pyrazol-3-yl]oxy-2-methoxyimino-N,3 dimethyl-pent-3-en-amide, pyriminostrobin, bifujunzhi, 2-(ortho-((2,5-dimethylphenyl-oxy-methylen)phenyl)-3-methoxy-acrylic acid methylester,
   preferably from azoxystrobin, dimoxystrobin, fluoxastrobin, metyltetraprole, orysastrobin, picoxystrobin, pyraclostrobin, trifloxystrobin and metyltetraprole.
c) cyazofamid, amisulbrom, [(6S,7R,8R) 8 benzyl-3-[(3-hydroxy-4-methoxy-pyridine-2-carbonyl)amino]-6-methyl-4,9-dioxo-1,5-dioxonan-7-yl] 2-methylpropanoate, fenpicoxamid, florylpicoxamid,
   preferably from cyazofamid, amisulbrom and fenpicoxamid,
   more preferred from cyazofamid and amisulbrom;
d) benodanil, benzovindiflupyr, bixafen, boscalid, carboxin, fenfuram, fluopyram, flutolanil, fluxapyroxad, furametpyr, isofetamid, isopyrazam, mepronil, oxycarboxin, penflufen, penthiopyrad, pydiflumetofen, pyraziflumid, sedaxane, tecloftalam, thifluzamide, inpyrfluxam, pyrapropoyne, fluindapyr, N-[2-[2-chloro-4-(trifluoro-methyl)phenoxy]phenyl]-3-(difluoromethyl)-5-fluoro-1-methyl-pyrazole-4-carboxamide, methyl (E)-2-[2-[(5-cyano-2-methyl-phenoxy)methyl]phenyl]-3-methoxy-prop-2 enoate, isoflucypram, 2-(difluoromethyl)-N-(1,1,3-trimethyl-indan-4 yl)-pyridine-3-carboxamide, 2-(difluoromethyl)-N-[(3R)-1,1,3-trimethylindan-4-yl]¬pyridine-3-carboxamide, 2-(difluoromethyl)-N-(3-ethyl-1,1-dimethyl-indan-4-yl) ¬pyridine-3-carboxamide, 2-(difluoromethyl)-N-[(3R)-3-ethyl-1,1-dimethyl-indan-4-yl]-pyridine-3-carboxamide, 2-(difluoromethyl)-N-(1,1-dimethyl-3-propyl-indan-4-yl)-pyridine-3-carboxamide, 2-(difluoromethyl)-N-[(3R)-1,1-dimethyl-3-propyl-indan-4-yl]¬pyridine-3-carboxamide, 2-(difluoromethyl)-N-(3-isobutyl-1,1-dimethyl-indan-4-yl)¬pyridine-3-carboxamide, 2-(difluoromethyl)-N-[(3R)-3-isobutyl-1,1-dimethyl-indan-4 yl]pyridine-3-carboxamide,
   preferably from benzovindiflupyr, bixafen, boscalid, fluopyram, fluxapyroxad, isofetamid, penflufen, penthiopyrad, pydiflumetofen, sedaxane, inpyrfluxam, fluindapyr, isoflucypram,
   more preferred from, benzovindiflupyr, bixafen, boscalid, fluopyram, fluxapyroxad, pen- flufen, penthiopyrad, sedaxane;
e) fluazinam, ametoctradin, silthiofam, spiroxamine, fludioxonil, fenhexamid, metalaxyl, metalaxyl-M, dithianon,
   preferably from fluazinam, ametoctradin, silthiofam, spiroxamine, fludioxonil, metalaxyl, metalaxyl-M and dithianon; more preferred fluazinam, ametoctradin, silthiofam, spiroxamine, metalaxyl, metalaxyl-M and dithianon
f) azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothio - conazole, simeconazole, tebuconazole, tetraconazole, triadimefon, triadimenol, triticonazole, uniconazole, 2 (2,4-difluoro-phenyl)-1,1-difluoro-3-(tetrazol-1-yl)-1-[5-[4-(2,2,2-trifluoroethoxy)phenyl]-2 pyridyl]propan-2-ol, 2-(2,4-difluorophenyl)-1,1-difluoro-3-(tetrazol-1-yl)-1 [5 [4 (tri¬fluoromethoxy)phenyl]-2-pyridyl]propan-2-ol, 4-[[6-[2-(2,4-difluorophenyl)-1,1-difluo¬ro-2-hydroxy-3-(5-sulfanyl-1,2,4-triazol-1-yl)propyl]-3-pyridyl]oxy]benzonitrile, ipfen¬trifluconazole, mefentrifluconazole, (2R)-2-[4-(4-chlorophen¬oxy)-2-(trifluoromethyl)phenyl]-1-(1,2,4-triazol-1-yl)propan-2-ol, (2S)-2-[4-(4-chlorophenoxy)-2-(trifluoromethyl)phenyl]-1-(1,2,4-triazol-1-yl)propan-2-ol , 2-(chloromethyl)-2-methyl-5-(p-toly¬methyl)-1 (1,2,4-triazol-1 ylmethyl)cyclopentanol; imidazoles: imazalil, pefurazoate, prochloraz, triflumizol, pyrimidines, pyridines, piperazines: fenarimol, pyrifenox, triforine, [3-(4-chloro-2-fluoro-phenyl)-5-(2,4-di¬fluoro-phenyl)isoxazol-4-yl]-(3-pyridyl)methanol, 4-[[6-[2-(2,4-difluorophenyl)-1,1-di¬flu¬oro-2-hydroxy-3-(1,2,4-triazol-1-yl)propyl]-3-pyridyl]oxy]¬benzo¬nitrile, 2-[6-(4-bro¬mo-phenoxy)-2-(trifluoromethyl)-3-pyridyl]-1-(1,2,4-triazol-1 yl)propan-2-ol, 2-[6-(4-chlo-rophenoxy)-2-(trifluoromethyl)-3-pyridyl]-1-(1,2,4-triazol-1-yl)propan-2-ol, preferably from difenoconazole, epoxiconazole, ipconazole, metconazole, prothioconazole, tebuconazole, triadimenol, triticonazole and prochloraz;
g) thiabendazole, thiophanate-methyl, diethofencarb, ethaboxam, pencycuron, fluopicolide, zoxamide, metrafenone and pyriofenone,
   preferably from thiabendazole, thiophanate-methyl, ethaboxam, fluopicolide, zoxamide, metrafenone, pyriofenone,
   more preferred from ethaboxam, fluopicolide, zoxamide, metrafenone, pyriofenone;
h) cyprodinil, mepanipyrim, pyrimethanil, preferably pyrimethanil;
i) dimethomorph, flumorph, mandipropamid, pyrimorph, benthiavalicarb, iprovalicarb, valifenalate, preferably from dimethomorph, mandipropamid, benthiavalicarb, iprovalicarb, valifenalate;
j) oxathiapiprolin, fluoxapiprolin, 4 [1 [2 [3-(difluoromethyl)-5-methyl-pyrazol-1-yl]acetyl]-4-piperidyl]-N-te¬tralin-1-yl-pyridine-2 carboxamide, 4-[1-[2-[3,5-bis(difluoromethyl)pyrazol-1-yl]acetyl]-4-piperidyl]-N-tetralin-1-yl-pyridine-2-carboxamide, 4-[1-[2-[3-(difluoromethyl)-5-(trifluoromethyl)pyrazol-1-yl]acetyl]-4-piperidyl]-N-tetralin-1-yl-pyridine-2-carboxamide, 4-[1-[2-[5-cyclopropyl-3-(difluoromethyl)pyrazol-1-yl]acetyl]-4-piperidyl]-N-tetralin-1-yl-pyridine-2-carboxamide, 4-[1-[2-[5-methyl-3-(trifluoromethyl)pyrazol-1-yl]acetyl]-4-piperidyl]-N-tetralin-1-yl-pyridine-2-carboxamide, 4-[1-[2-[5-(difluoromethyl)-3-(trifluoro¬methyl)pyrazol-1yl]acetyl]-4-piperidyl]-N-tetralin-1-yl-pyridine-2-carboxamide, 4 [1-[2-[3,5-bis(trifluoromethyl)pyrazol-1-yl]acetyl]-4-piperidyl]-N-tetralin-1-yl-pyridine-2-car¬boxamide, (4 [1-[2-[5-cyclopropyl-3-(trifluoromethyl)pyrazol-1-yl]acetyl]-4-piperidyl]-N-tetralin-1-yl-pyridine-2-carboxamide,
   preferably from oxathiapiprolin and fluoxapiprolin,
   more preferred is oxathiapiprolin.
k) ferbam, mancozeb, maneb, metam, metiram, propineb, thiram, zineb, ziram, preferably from mancozeb, metiram and thiram;
l) fosetyl, fosetyl-aluminum, phosphorous acid and its salts, calcium phosphonate, potassium phosphonate, preferably from fosetyl and fosetyl-aluminum;
m) cymoxanil, fenpyrazamine, triazoxide, picarbutrazox, preferred is cymoxanil,
   wherein the fungicide of component 2 and the fungicide of component 3 are not identical.

Preferably component 3 is difenoconazole, prothioconazol, mefentrifluconazol, metconazole, triticonazol, difenoconazol, triadimenol, prochloraz, tebuconazol, epoxiconazol, ipconazol, metalaxyl-M, mefenoxam, spiroxamine, fludioxonil, penflufen, bixafen, fluxapyroxad, boscalid, benzovindiflupyr, fluopyram, penthiopyrad, sedaxan, pyrimethanil, fluoxastrobin, metyltetraprole, azoxystrobin, trifloxystrobin, pyraclostrobin, dimoxystrobin, picoxystrobin, orysastrobin, cyazofamid, amisulbrom, thiabendazole, thiophanate-methyl, zoxamide, ethaboxam, cymoxanil, picarbutrazox, fluazinam, valifenalate, benthiavalicarb, iprovalicarb, mandipropamid, dimethomorph, fluopicolide, ametoctradin, silthiofam oxathiapiprolin, pyriofenone, metrafenone, metiram, mancozeb, thiram, dithianon, fosetyl or fosetyl-aluminium, wherein the fungicide of component 2 and the fungicide of component 3 are not identical.

In cases in which the mixture comprises also fusaricidin 1A and/or fusaricidin 1B or cells or spores of a Paenibacillus strain, which is capable to produce fusaricidin 1A and/or fusaricidin 1B, component 3 is preferably difenoconazole, prothioconazol, mefentrifluconazol, metconazole, triticonazol, difenoconazol, triadimenol, prochloraz, tebuconazol, epoxiconazol, ipconazol, metalaxyl-M, mefenoxam, spiroxamine, fludioxonil, penflufen, bixafen, fluxapyroxad, boscalid, benzovindiflupyr, fluopyram, penthiopyrad, sedaxan, pyrimethanil, fluoxastrobin, metyltetraprole, azoxystrobin, trifloxystrobin, pyraclostrobin, dimoxystrobin, picoxystrobin, orysastrobin, cyazofamid, amisulbrom, thiabendazole, thiophanate-methyl, zoxamide, ethaboxam, cymoxanil, picarbutrazox, fluazinam, valifenalate, benthiavalicarb, iprovalicarb, mandipropamid, dimethomorph, fluopicolide, ametoctradin, silthiofam oxathiapiprolin, pyriofenone, metrafenone, metiram, mancozeb, thiram, dithianon, fosetyl or fosetyl-aluminium, wherein the fungicide of component 2 and the fungicide of component 3 are not identical . . .

Fungicides which show synergistic effects with fusaricidin 1A and/or fusaricidin 1B are difenoconazole, prothioconazole, mefentrifluconazole, metconazole, triticonazole, difenoconazole, triadimenole, prochloraz, tebuconazole, epoxiconazole, ipconazole, metalaxyl-M, penflufene, bixafene, fluxapyroxad, benzovindiflupyr, fluopyram, penthiopyrad, sedaxane, pyrimethanil, azoxystrobin, trifloxystrobin, pyraclostrobin, dimoxystrobin, picoxystrobin, orysastrobin, ethaboxam, dimethomorph, thiram, picarbutrazox, fludioxonil, thiophanate, thiophanate-methyl, thiabendazole and silthiofam wherein the fungicide of component 2 and the fungicide of component 3 are not identical.

In one embodiment component 2 is spiroxamine and component 3 is benodanil, benzovindiflupyr, bixafen, boscalid, carboxin, fenfuram, fluopyram, flutolanil, fluxapyroxad, furametpyr, isofetamid, isopyrazam, mepronil, oxycarboxin, penflufen, penthiopyrad, pydiflumetofen, pyraziflumid, sedaxane, tecloftalam, thifluzamide, inpyrfluxam, pyrapropoyne, fluindapyr, N-[2-[2-chloro-4-(trifluoro-methyl)phenoxy]phenyl]-3-(difluoromethyl)-5-fluoro-1-methyl-pyrazole-4-carboxamide, methyl (E)-2-[2-[(5-cyano-2-methyl-phenoxy)methyl]phenyl]-3-methoxy-prop-2 enoate, isoflucypram, 2-(difluoromethyl)-N-(1,1,3-trimethyl-indan-4 yl)-pyridine-3-carboxamide, 2-(difluoromethyl)-N-[(3R)-1,1,3-trimethylindan-4-yl]¬pyridine-3-carboxamide, 2-(difluoromethyl)-N-(3-ethyl-1,1-dimethyl-indan-4-yl)¬pyridine-3-carboxamide, 2-(difluoromethyl)-N-[(3R)-3-ethyl-1,1-dimethyl-indan-4-yl ]-pyridine-3-carboxamide, 2-(difluoromethyl)-N-(1,1-dimethyl-3-propyl-indan-4-yl)-pyridine-3-carboxamide, 2-(difluoromethyl)-N-[(3R)-1,1-dimethyl-3-propyl-indan-4-yl]¬pyridine-3-carboxamide, 2-(difluoromethyl)-N-(3-isobutyl-1,1-dimethyl-indan-4-yl)¬pyridine-3-carboxamide, or 2-(difluoromethyl)-N-[(3R)-3-isobutyl-1,1-dimethyl-indan-4 yl]pyridine-3-carboxamide,

preferably component 3 is benzovindiflupyr, bixafen, boscalid, fluopyram, fluxapyroxad, isofetamid, penflufen, penthiopyrad, pydiflumetofen, sedaxane, inpyrfluxam, fluindapyr and isoflucypram,

more preferred, component 3 is benzovindiflupyr, bixafen, boscalid, fluopyram, fluxapyroxad, penflufen, penthiopyrad or sedaxane, and most preferred component 3 is fluopyram.

In one embodiment component 2 is boscalid or fluxapyroxad and component 3 is azoxystrobin, coumethoxystrobin, coumoxystrobin, dimoxystrobin, enestroburin, fenaminstrobin, fenoxystrobin/flufenoxystrobin, fluoxastrobin, metyltetraprole, kresoxim-methyl, mandestrobin, metominostrobin, orysastrobin, picoxystrobin, pyraclostrobin, pyrametostrobin, pyraoxystrobin, trifloxystrobin, 2 (2-(3-(2,6-di-chlorophenyl)-1-methyl-allylideneaminooxymethyl)-phenyl)-2 methoxyimino-N methyl-acetamide, pyribencarb, triclopyricarb/chlorodincarb, famoxadone, fenamidone, methyl-N-[2-[(1,4-dimethyl-5 phenyl-pyrazol-3-yl)oxylmethyl]phenyl]-N-methoxy-carbamate, metyltetraprole, (Z,2E) 5 [1-(2,4-dichloro-phenyl)pyrazol-3-yl]-oxy-2-methoxyimino-N,3-dimethyl-pent-3-en-amide, (Z,2E) 5 [1 (4-chlorophenyl)pyrazol-3-yl]oxy-2-methoxyimino-N,3 dimethyl-pent-3-enamide, pyriminostrobin, bifujunzhi or 2-(ortho-((2,5-dimethylphenyl-oxy-methylen)phenyl)-3-methoxy-acrylic acid methylester,

preferably, component 3 is kresoxim-methyl, azoxystrobin, dimoxystrobin, fluoxastrobin, metyltetraprole, orysastrobin, picoxystrobin, pyraclostrobin, trifloxystrobin or metyltetraprole, more preferred, component 3 is kresoxim-methyl or pyraclostrobin

In one embodiment component 2 is pyrimethanil and component 3 is fluazinam, ametoctradin, silthiofam, spiroxamine, fludioxonil, fenhexamid, metalaxyl, metalaxyl-M or dithianon, Preferably, component 3 is fluazinam, ametoctradin, silthiofam, spiroxamine, fludioxonil, metalaxyl, metalaxyl-M or dithianon; more preferred, component 3 is fluazinam, ametoctradin, silthiofam, spiroxamine, metalaxyl, metalaxyl-M or dithianon.

In one embodiment component 2 is pyrimethanil and component 3 is azoxystrobin, coumethoxystrobin, coumoxystrobin, dimoxystrobin, enestroburin, fenaminstrobin, fenoxystrobin/flufenoxystrobin, fluoxastrobin, metyltetraprole, kresoxim-methyl, mandestrobin, metominostrobin, orysastrobin, picoxystrobin, pyraclostrobin, pyrametostrobin, pyraoxystrobin, trifloxystrobin, 2 (2-(3-(2,6-di-chlorophenyl)-1-methyl-allylideneaminooxymethyl)-phenyl)-2 methoxyimino-N methyl-acetamide, pyribencarb, triclopyricarb/chlorodincarb, famoxadone, fenamidone, methyl-N-[2-[(1,4-dimethyl-5 phenyl-pyrazol-3-yl)oxylmethyl]phenyl]-N-methoxy-carbamate, metyltetraprole, (Z,2E) 5 [1-(2,4-dichloro-phenyl)pyrazol-3-yl]-oxy-2-methoxyimino-N,3-dimethyl-pent-3-en-amide, (Z,2E) 5 [1 (4-chlorophenyl)pyrazol-3-yl]oxy-2-methoxyimino-N,3 dimethyl-pent-3-enamide, pyriminostrobin, bifujunzhi or 2-(ortho-((2,5-dimethylphenyl-oxy-methylen)phenyl)-3-methoxy-acrylic acid methylester, preferably, component 3 is azoxystrobin, dimoxystrobin, fluoxastrobin, metyltetraprole, orysastrobin, picoxystrobin, pyraclostrobin, trifloxystrobin or metyltetraprole.

In one embodiment component 2 is trifloxystrobin, fluoxastrobin or metyltetraprole and component 3 is cyprodinil, mepanipyrim or pyrimethanil, preferably, component 3 is pyrimethanil.

In one embodiment component 2 is trifloxystrobin, fluoxastrobin or metyltetraprole and component 3 is benodanil, benzovindiflupyr, bixafen, boscalid, carboxin, fenfuram, fluopyram, flutolanil, fluxapyroxad, furametpyr, isofetamid, isopyrazam, mepronil, oxycarboxin, penflufen, penthiopyrad, pydiflumetofen, pyraziflumid, sedaxane, tecloftalam, thifluzamide, inpyrfluxam, pyrapropoyne, fluindapyr, N-[2-[2-chloro-4-(trifluoro-methyl)phenoxy]phenyl]-3-(difluoromethyl)-5-fluoro-1-methyl-pyrazole-4-carboxamide, methyl (E)-2-[2-[(5-cyano-2-methyl-phenoxy)methyl]phenyl]-3-methoxy-prop-2 enoate, isoflucypram, 2-(difluoromethyl)-N-(1,1,3-trimethyl-indan-4 yl)-pyridine-3-carboxamide, 2-(difluoromethyl)-N-[(3R)-1,1,3-trimethylindan-4-yl]¬pyridine-3-carboxamide, 2-(difluoromethyl)-N-(3-ethyl-1,1-dimethyl-indan-4-yl)¬pyridine-3-carboxamide, 2-(difluoromethyl)-N-[(3R)-3-ethyl-1,1-dimethyl-indan-4-yl]-pyridine-3-carboxamide, 2-(difluoromethyl)-N-(1,1-dimethyl-3-propyl-indan-4-yl)-pyridine-3-carboxamide, 2-(difluoromethyl)-N-[(3R)-1,1-dimethyl-3-propyl-indan-4-yl]¬pyridine-3-carboxamide, 2-(difluoromethyl)-N-(3-isobutyl-1,1-dimethyl-indan-4-yl)¬pyridine-3-carboxamide or 2-(difluoromethyl)-N-[(3R)-3-isobutyl-1,1-dimethyl-indan-4 yl]pyridine-3-carboxamide,

preferably component 3 is benzovindiflupyr, bixafen, boscalid, fluopyram, fluxapyroxad, isofetamid, penflufen, penthiopyrad, pydiflumetofen, sedaxane, inpyrfluxam or fluindapyr, isoflucypram,

more preferred component 3 is benzovindiflupyr, bixafen, boscalid, fluopyram, fluxapyroxad, penflufen, penthiopyrad or sedaxane.

In one embodiment component 2 is zoxamide or ethaboxam and component 3 is dimethomorph, flumorph, mandipropamid, pyrimorph, benthiavalicarb, iprovalicarb or valifenalate, preferably, component 3 is dimethomorph, mandipropamid, benthiavalicarb, iprovalicarb or valifenalate;

In one embodiment component 2 is zoxamide or ethaboxam and component 3 is oxathiapiprolin, fluoxapiprolin, 4 [1 [2 [3-(difluoromethyl)-5-methyl-pyrazol-1-yl]acetyl]-4-piperidyl]-N-te¬tralin-1-yl-pyridine-2 carboxamide, 4-[1-[2-[3,5-bis(difluoromethyl)pyrazol-1-yl]acetyl]-4-piperidyl]-N-tetralin-1-yl-pyridine-2-carboxamide, 4-[1-[2-[3-(difluoromethyl)-5-(trifluoromethyl)pyrazol-1-yl]acetyl]-4-piperidyl]-N-tetralin-1-yl-pyridine-2-carboxamide, 4-[1-[2-[5-cyclopropyl-3-(difluoromethyl)pyrazol-1-yl]acetyl]-4-piperidyl]-N-tetralin-1-yl-pyridine-2-carboxamide, 4-[1-[2-[5-methyl-3-(trifluoromethyl)pyrazol-1-yl]acetyl]-4-piperidyl]-N-tetralin-1-yl-pyridine-2-carboxamide, 4-[1-[2-[5-(difluoromethyl)-3-(trifluoro¬methyl)pyrazol-1 yl]acetyI]-4-piperidyl]-N-tetralin-1-yl-pyridine-2-carboxamide, 4 [1 [2-[3,5-bis(trifluoromethyl)pyrazol-1-yl]acetyl]-4-piperidyl]-N-tetralin-1-yl-pyridine-2-carboxamide or (4 [1-[2-[5-cyclopropyl-3-(trifluoromethyl)pyrazol-1-yl]acetyl]-4-piperidyl]-N-tetralin-1-yl-pyridine-2-carboxamide,

preferably component 3 is oxathiapiprolin or fluoxapiprolin,

more preferred component 3 is oxathiapiprolin.

In one embodiment component 2 is zoxamide or ethaboxam, and component 3 is ferbam, mancozeb, maneb, metam, metiram, propineb, thiram, zineb or ziram, preferably component 3 is mancozeb, metiram and thiram.

In one embodiment component 2 is cymoxanil and component 3 is dimethomorph, flumorph, mandipropamid, pyrimorph, benthiavalicarb, iprovalicarb, valifenalate, preferably component 3 is dimethomorph, mandipropamid, benthiavalicarb, iprovalicarb or valifenalate.

In one embodiment component 2 is valifenalate, benthiavalicarb, iprovalicarb, mandipropamid or dimethomorph, preferably component 2 is valifenalate, benthiavalicarb, iprovalicarb or mandipropamid and component 3 is azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothio¬conazole, simeconazole, tebuconazole, tetraconazole, triadimefon, triadimenol, triticonazole, uniconazole, 2 (2,4-difluorophenyl)-1,1-difluoro-3-(tetrazol-1-yl)-1-[5-[4-(2,2,2-trifluoroethoxy)phenyl]-2 pyridyl]propan-2-ol, 2-(2,4-difluorophenyl)-1,1-difluoro-3-(tetrazol-1-yl)-1 [5 [4 (trifluoromethoxy)phenyl]-2-pyridyl]propan-2-ol, 4-[[6-[2-(2,4-difluorophenyl)-1,1-difluo¬ro-2-hydroxy-3-(5-sulfanyl-1,2,4-triazol-1-yl)propyl]-3-pyridyl]oxy]benzonitrile, ipfen¬trifluconazole, mefentrifluconazole, (2R)-2-[4-(4-chlorophen¬oxy)-2-(trifluo¬ro¬methyl)phenyl]-1-(1,2,4-triazol-1-yl)propan-2-ol, (2S)-2-[4-(4-chlorophenoxy)-2-(trifluoromethyl)phenyl]-1-(1,2,4-triazol-1-yl)propan-2-ol , 2-(chloromethyl)-2-methyl-5-(p-tolylmethyl)-1 (1,2,4-triazol-1 ylmethyl)cyclopentanol; imidazoles: imazalil, pefurazoate, prochloraz, triflumizol, pyrimidines, pyridines, piperazines: fenarimol, pyrifenox, triforine, [3-(4-chloro-2-fluoro-phenyl)-5-(2,4-di¬fluoro-phenyl)isoxazol-4-yl]-(3-pyridyl)methanol, 4-[[6-[2-(2,4-difluorophenyl)-1,1-di¬flu¬oro-2-hydroxy-3-(1,2,4-triazol-1-yl)propyl]-3-pyridyl]oxy]¬benzo¬ni¬trile, 2-[6-(4-bro¬mo-phenoxy)-2-(trifluoromethyl)-3-pyridyl]-1-(1,2,4-triazol-1yl)propan-2-ol, or 2-[6-(4-chlo-rophenoxy)-2-(trifluoromethyl)-3-pyridyl]-1-(1,2,4-triazol-1-yl)propan-2-ol, preferably component 3 is difenoconazole, epoxiconazole, ipconazole, metconazole, prothioconazole, tebuconazole, triadimenol, triticonazole and prochloraz.

In one embodiment component 2 is valifenalate, benthiavalicarb, iprovalicarb, mandipropamid or dimethomorph, preferably component 2 is valifenalate, benthiavalicarb, iprovalicarb or mandipropamid and component 3 is cymoxanil, fenpyrazamine, triazoxide, or picarbutrazox, preferably component 3 is cymoxanil,

In one embodiment component 2 is valifenalate, benthiavalicarb, iprovalicarb, mandipropamid or dimethomorph, preferably component 2 is valifenalate, benthiavalicarb, iprovalicarb or mandi- propamid and component 3 is azoxystrobin, coumethoxystrobin, coumoxystrobin, dimoxystrobin, enestroburin, fenaminstrobin, fenoxystrobin/flufenoxystrobin, fluoxastrobin, metyltetraprole, kresoxim-methyl, mandestrobin, metominostrobin, orysastrobin, picoxystrobin, pyraclostrobin, pyrametostrobin, pyraoxystrobin, trifloxystrobin, 2 (2-(3-(2,6-di-chlorophenyl)-1-methyl-allylideneaminooxymethyl)-phenyl)-2 methoxyimino-N methyl-acetamide, pyribencarb, triclopyricarb/chlorodincarb, famoxadone, fenamidone, methyl-N-[2-[(1,4-dimethyl-5 phenyl-pyrazol-3-yl)oxylmethyl]phenyl]-N-methoxy-carbamate, metyltetraprole, (Z,2E) 5 [1-(2,4-dichloro¬phenyl)pyrazol-3-yl]-oxy-2-methoxyimino-N,3-dimethyl-pent-3-en-amide, (Z,2E) 5 [1 (4-chlorophenyl)pyrazol-3-yl]oxy-2-methoxyimino-N,3 dimethyl-pent-3-enamide, pyriminostrobin, bifujunzhi, or 2-(ortho-((2,5-dimethylphenyl-oxy-methylen)phenyl)-3-methoxy-acrylic acid methylester,

preferably component 3 is azoxystrobin, dimoxystrobin, fluoxastrobin, metyltetraprole, orysastrobin, picoxystrobin, pyraclostrobin, trifloxystrobin or metyltetraprole.

In one embodiment component 2 is valifenalate, benthiavalicarb, iprovalicarb, mandipropamid or dimethomorph, preferably component 2 is valifenalate, benthiavalicarb, iprovalicarb or mandi- propamid and component 3 is thiabendazole, thiophanate-methyl, diethofencarb, ethaboxam, pencycuron, fluopicolide, zoxamide, metrafenone or pyriofenone,

preferably component 3 is thiabendazole, thiophanate-methyl, ethaboxam, fluopicolide, zoxamide, metrafenone or pyriofenone,

more preferred component 3 is ethaboxam, fluopicolide, zoxamide, metrafenone or pyriofenone;

In one embodiment component 2 is fluopicolide and component 3 is fosetyl, fosetyl-aluminum, phosphorous acid and its salts, calcium phosphonate or potassium phosphonate, preferably component 3 is fosetyl or fosetyl-aluminum.

In one embodiment component 2 is ametoctradin and component 3 is dimethomorph, flumorph, mandipropamid, pyrimorph, benthiavalicarb, iprovalicarb or valifenalate, preferably at least one further fungicide is dimethomorph, mandipropamid, benthiavalicarb, iprovalicarb or valifenalate.

In one embodiment component 2 is oxathiapiprolin or fluoxapiprolin, preferably component 2 is oxathiapiprolin and component 3 is thiabendazole, thiophanate-methyl, diethofencarb, ethaboxam, pencycuron, fluopicolide, zoxamide, metrafenone or pyriofenone, preferably component 3 is thiabendazole, thiophanate-methyl, ethaboxam, fluopicolide, zoxamide, metrafenone or pyriofenone, more preferred component 3 is ethaboxam, fluopicolide, zoxamide, metrafenone or pyriofenone;

In one embodiment component 2 is metiram, mancozeb or thiram, preferably component 2 is metiram or mancozeb and component 3 is thiabendazole, thiophanate-methyl, diethofencarb, ethaboxam, pencycuron, fluopicolide, zoxamide, metrafenone or pyriofenone, preferably component 3 is thiabendazole, thiophanate-methyl, ethaboxam, fluopicolide, zoxamide, metrafenone or pyriofenone, more preferred component 3 is ethaboxam, fluopicolide, zoxamide, metrafenone or pyriofenone.

In one embodiment component 2 is metiram, mancozeb or thiram, preferably component 2 is metiram or mancozeb and component 3 is benalaxyl, benalaxyl-M, kiralaxyl, metalaxyl, metalaxyl-M, ofurace, oxadixyl; preferably component 3 is metalaxyl or metalaxyl-M.

In one embodiment component 2 is metiram, mancozeb or thiram, preferably component 2 is metiram or mancozeb and component 3 is dimethomorph, flumorph, mandipropamid, pyrimorph, benthiavalicarb, iprovalicarb or valifenalate, preferably component 3 is dimethomorph, mandipropamid, benthiavalicarb, iprovalicarb or valifenalate.

In one embodiment component 2 is dithianon and component 3 is cyprodinil, mepanipyrim or pyrimethanil, preferably component 3 is pyrimethanil.

In one embodiment component 2 is dithianon and component 3 is dimethomorph, flumorph, mandipropamid, pyrimorph, benthiavalicarb, iprovalicarb or valifenalate, preferably component 3 is dimethomorph, mandipropamid, benthiavalicarb, iprovalicarb or valifenalate.

In one embodiment component 2 is fosetyl or fosetyl aluminium and component 3 is benodanil, benzovindiflupyr, bixafen, boscalid, carboxin, fenfuram, fluopyram, flutolanil, fluxapyroxad, furametpyr, isofetamid, isopyrazam, mepronil, oxycarboxin, penflufen, penthiopyrad, pydiflumetofen, pyraziflumid, sedaxane, tecloftalam, thifluzamide, inpyrfluxam, pyrapropoyne, fluindapyr, N-[2-[2-chloro-4-(trifluoro-methyl)phenoxy]phenyl]-3-(difluoromethyl)-5-fluoro-1-methyl-pyrazole-4-carboxamide, methyl (E)-2-[2-[(5-cyano-2-methyl-phenoxy)methyl]phenyl]-3-methoxy-prop-2 enoate, isoflucypram, 2-(difluoromethyl)-N-(1,1,3-trimethyl-indan-4 yl)-pyridine-3-carboxamide, 2-(difluoromethyl)-N-[(3R)-1,1,3-trimethylindan-4-yl]¬pyridine-3-carboxamide, 2-(difluoromethyl)-N-(3-ethyl-1,1-dimethyl-indan-4-yl)¬pyridine-3-carboxamide, 2-(difluoromethyl)-N-[(3R)-3-ethyl-1,1-dimethyl-indan-4-yl]-pyridine-3-carboxamide, 2-(difluoromethyl)-N-(1,1-dimethyl-3-propyl-indan-4-yl)-pyridine-3-carboxamide, 2-(difluoromethyl)-N-[(3R)-1,1-dimethyl-3-propyl-indan-4-yl]-pyridine-3-carboxamide, 2-(difluoromethyl)-N-(3-isobutyl-1,1-dimethyl-indan-4-yl)¬pyridine-3-carboxamide or 2-(difluoromethyl)-N-[(3R)-3-isobutyl-1,1-dimethyl-indan-4 yl]pyridine-3-carboxamide, preferably component 3 is benzovindiflupyr, bixafen, boscalid, fluopyram, fluxapyroxad, isofetamid, penflufen, penthiopyrad, pydiflumetofen, sedaxane, inpyrfluxam, fluindapyr, or isoflucypram, more preferred component 3 is benzovindiflupyr, bixafen, boscalid, fluopyram, fluxapyroxad, penflufen, penthiopyrad or sedaxane

In one embodiment component 2 is fosetyl or fosetyl aluminium and component 3 is thiabendazole, thiophanate-methyl, diethofencarb, ethaboxam, pencycuron, fluopicolide, zoxamide, metrafenone or pyriofenone, preferably component 3 is thiabendazole, thiophanate-methyl, ethaboxam, fluopicolide, zoxamide, metrafenone or pyriofenone, more preferred component 3 is ethaboxam, fluopicolide, zoxamide, metrafenone or pyriofenone.

Preferably the fungicide of component 2 is boscalid, trifloxystrobin, zoxamide, cymoxanil, mandipropamid, iprovalicarb, fluopicolide, ametoctradin, oxathiapiprolin, metiram, mancozeb, dithianon, fosetyl or fosetyl-aluminium.

In one embodiment the fungicide of component 2 is spiroxamine, boscalid, pyrimethanil, fluoxastrobin, metyltetraprole, trifloxystrobin, cyazofamid, amisulbrom, zoxamide, cymoxanil, fluazinam, valifenalate, benthiavalicarb, iprovalicarb, mandipropamid, fluopicolide, ametoctradin, oxathiapiprolin, pyriofenone, metrafenone, metiram, mancozeb, dithianon, fosetyl or fosetyl-aluminium (fosetyl-Al) and the fungicide of component 3 are spiroxamine, boscalid, pyrimethanil, fluoxastrobin, metyltetraprole, trifloxystrobin, cyazofamid, amisulbrom, zoxamide, cymoxanil, fluazinam, valifenalate, benthiavalicarb, iprovalicarb, mandipropamid, fluopicolide, ametoctradin, oxathiapiprolin, pyriofenone, metrafenone, metiram, mancozeb, dithianon, fosetyl or fosetyl-aluminium (fosetyl-Al), wherein the fungicide of component 2 and the fungicide of component 3 are not identical.

In one embodiment the fungicide of component 2 is difenoconazole, spiroxamine, fluxapyroxad, boscalid, fluindapyr, isoflucypram, inpyrfluxam, pydiflumetofen, pyrimethanil, fluoxastrobin, metyltetraprole, trifloxystrobin, cyazofamid, amisulbrom, zoxamide, cymoxanil, fluazinam, valifenalate, benthiavalicarb, iprovalicarb, mandipropamid, dimethomorph, fluopicolide, ametoctradin, oxathiapiprolin, pyriofenone, metrafenone, metiram, mancozeb, dithianon, fosetyl or fosetyl-Al, preferably spiroxamine, trifloxystrobin, cymoxanil, iprovalicarb, mandipropamid, fluopicolide, oxathiapiprolin, metiram, mancozeb, fosetyl or fosetyl-Al and the fungicide of component 3 is prothioconazole, fluopyram, pyrimethanil, fluoxapiprolin or propamocarb, preferably prothioconazole, pyrimethanil, fluoxapiprolin or propamocarb, even more preferred prothioconazole.

In one embodiment the fungicide of component 2 is boscalid, fluoxastrobin, metyltetraprole, cyazofamid, amisulbrom, zoxamide, benthiavalicarb, iprovalicarb, ametoctradin, pyriofenone, metrafenone or dithianon and the fungicide of component 3 is difenoconazole, spiroxamine, fluxapyroxad, boscalid, fluindapyr, isoflucypram, inpyrfluxam, pydiflumetofen, pyrimethanil, fluoxastrobin, metyltetraprole, trifloxystrobin, cyazofamid, amisulbrom, zoxamide, cymoxanil, fluazinam, valifenalate, benthiavalicarb, iprovalicarb, mandipropamid, dimethomorph, fluopicolide, ametoctradin, oxathiapiprolin, pyriofenone, metrafenone, metiram, mancozeb, dithianon, fosetyl or fosetyl-Al, preferably spiroxamine, trifloxystrobin, cymoxanil, iprovalicarb, mandipropamid, fluopicolide, oxathiapiprolin, metiram, mancozeb, fosetyl or fosetyl-Al, wherein the fungicide of component 2 and the fungicide of component 3 are not identical.

In one embodiment the fungicide of component 2 is boscalid, fluoxastrobin, metyltetraprole, cyazofamid, amisulbrom, zoxamide, benthiavalicarb, iprovalicarb, ametoctradin, pyriofenone, metrafenone or dithianon and the fungicide of component 3 is spiroxamine, boscalid, fluoxastrobin, metyltetraprole, trifloxystrobin, cyazofamid, amisulbrom, zoxamide, cymoxanil, fluazinam, valifenalate, benthiavalicarb, iprovalicarb, mandipropamid, fluopicolide, ametoctradin, oxathiapiprolin, pyriofenone, metrafenone, metiram, mancozeb, dithianon, fosetyl or fosetyl-Al, wherein the fungicide of component 2 and the fungicide of component 3 are not identical.

Similar preferred embodiments are mixtures in which,

component 2 is spiroxamine and component 3 is fluopyram, or

component 2 is boscalid and component 3 is pyraclostrobin, or

component 2 is pyrimethanil and component 3 is dithianon or trifloxystrobin, or

component 2 is trifloxystrobin and component 3 is pyrimethanil or fluopyram; or

component 2 is zoxamide and component 3 mandipropamid, oxathiapiprolin or mancozeb; or

component 2 is cymoxanil and component 3 is mandipropamid; or

component 2 is mandipropamid and component 3 is difenoconazole, cymoxanil, azoxystrobin and/or zooxamide; or

component 2 is fluopicolide and component 3 is fosetyl-aluminium; or

component 2 is ametoctradin and component 3 is dimethomorph; or

component 2 is oxathiapiprolin and component 3 is zoxamide; or

component 2 is mancozeb and component 3 is zoxamide, metalaxyl, metalaxyl-M or dimetho- morph; or

component 2 is dithianon and component 3 is pyrimethanil or dimethomorph; or

component 2 is fosetyl or fosetyl aluminium and component 3 fluopyram or fluopicolide.

The weight/weight ratios between component 1 and component 2 and, if applicable, between component 1 and component 3 is between 300:1 to 1:300, 250:1 to 1:250, 200:1 to 1:200, 150:1 to 1:150, 100:1 to 1:100, 90:1 to 1:90, 80:1 to 1:80, 70:1 to 1:70, 60:1 to 1:60, 50:1 to 1:50, 40:1 to 1:40, 30:1 to 1:30, 20:1 to 1:20, 10:1 to 1:10, 9:1 to 1:9, 8:1 to 1:8, 7:1 to 1:7, 6:1 to 1:6, 5:1 to 1:5, 4:1 to 1:4, 3:1 to 1:3, 2:1 to 1:2 and 1:1.

Preferred weight/weight ratios between component 1 and component 2 and, if applicable, between component 1 and component 3 are: 300:1 to 1:1, 250:1 to 1:1, 200:1 to 1:1, 150:1 to 1:1, 100:1 to 1:1, 90:1 to 1:1, 80:1 to 1:1, 70:1 to 1:1, 60:1 to 1:1, 50:1 to 1:1, 40:1 to 1:1, 30:1 to 1:1, 20:1 to 1:1, 10:1 to 1:1, 9:1 to 1:1, 8:1 to 1:1, 7:1 to 1:1, 6:1 to 1:1, 5:1 to 1:1, 4:1 to 1:1, 3:1 to 1:1, 2:1 to 1:1.

Also preferred weight/weight ratios between component 1 and component 2 and, if applicable, between component 1 and component 3 are: 1:1 to 1:300, 1:1 to 1:250, 1:1 to 1:200, 1:1 to 1:150, 1:1 to 1:100, 1:1 to 1:90, 1:1 to 1:80, 1:1 to 1:70, 1:1 to 1:60, 1:1 to 1:50, 1:1 to 1:40, 1:1 to 1:30, 1:1 to 1:20, 1:1 to 1:10, 1:1 to 1:9, 1:1 to 1:8, 1:1 to 1:7, 1:1 to 1:6, 1:1 to 1:5, 1:1 to 1:4, 1:1 to 1:3, 1:1 to 1:2.

More preferred weight/weight ratios between the total amount of fusaricidin A and fusaricidin B and the total amount of spiroxamine, cymoxanile, benthiavalicarbe, oxathiapiproline, pyriofenone, metrafenone, zoxamide, metiram and boscalid when used as component 2, or, if applicable, component 3, is selected from, is from 1:1 to 1:30, 1:1 to 1:20, 1:1 to 1:19, 1:1 to 1:18, 1:1 to 1:17, 1:1 to 1:16, 1:1 to 1:15, 1:1 to 1:14, 1:1 to 1:13, 1:1 to 1:12, 1:1 to 1:11, 1:1 to 1:10, 1:1 to 1:9, 1:1 to 1:8, 1:1 to 1:7, 1:1 to 1:6, 1:1 to 1:5, 1:1 to 1:4, 1:1 to 1:3, 1:1 to 1:2, more preferred from 1:1 to 1:20, 1:1 to 1:19, 1:1 to 1:18, 1:1 to 1:17, 1:1 to 1:16.

More preferred weight/weight ratios between the total amount of fusaricidin A and fusaricidin B and the total amount of valifenalate, ametoctradin, dithianon, fosetyl and fosetyl-Al when used as component 2, or, if applicable, component 3, is selected from, is from 20:1 to 1:20, 10:1 to 1:10, 9:1 to 1:9, 8:1 to 1:8, 7:1 to 1:7, 6:1 to 1:6, 5:1 to 1:5, 4:1 to 1:4, 3:1 to 1:3, 2:1 to 1:2 and 1:1, preferably from 5:1 to 1:5, 4:1 to 1:4, 3:1 to 1:3, 2:1 to 1:2 and 1:1.

More preferred weight/weight ratios between the total amount of fusaricidin A and fusaricidin B and the total amount of bixafene, fluoxastrobine, trifloxystrobine, metyltetraprole, cyazofamide, amisulbrome, fluaziname, iprovalicarbe, fluopicolide, metrafenone and mancozeb when used as component 2, or, if applicable, component 3, is selected from is from 300:1 to 1:1, 250:1 to 1:1, 200:1 to 1:1, 150:1 to 1:1, 100:1 to 1:1, 90:1 to 1:1, 80:1 to 1:1, 70:1 to 1:1, 60:1 to 1:1, 50:1 to 1:1, 40:1 to 1:1, 30:1 to 1:1, 20:1 to 1:1, 10:1 to 1:1, 9:1 to 1:1, 8:1 to 1:1, 7:1 to 1:1, 6:1 to 1:1, 5:1 to 1:1, 4:1 to 1:1, 3:1 to 1:1, 2:1 to 1:1, preferably from 250:1 to 1:1, 70:1 to 1:1 or 10:1 to 1:1.

More preferred weight/weight ratios between the total amount of fusaricidin A and fusaricidin B and the total amount of mandipropamide when used as component 2, or, if applicable, component 3, is from 1:1 to 1:100, 1:1 to 1:90, 1:1 to 1:80, 1:1 to 1:70, 1:1 to 1:60, 1:1 to 1:50, 1:1 to 1:40, 1:1 to 1:30, 1:1 to 1:20, 1:1 to 1:10, 1:1 to 1:9, 1:1 to 1:8, 1:1 to 1:7, 1:1 to 1:6, 1:1 to 1:5, 1:1 to 1:4, 1:1 to 1:3, 1:1 to 1:2, preferably from 1:1 to 1:80, 1:1 to 1:70, 1:1 to 1:60, 1:1 to 1:50, 1:1 to 1:40, 1:1 to 1:30, 1:1 to 1:20, 1:1 to 1:10, 1:1 to 1:9, 1:1 to 1:8, 1:1 to 1:7, 1:1 to 1:6, 1:1 to 1:5, 1:1 to 1:4, 1:1 to 1:3, 1:1 to 1:2.

The mixtures can be converted into customary types of agrochemical compositions, e. g. solutions, emulsions, suspensions, dusts, powders, pastes, granules, pressings, capsules, and mixtures thereof. Examples for composition types (see also “Catalogue of pesticide formulation types and international coding system”, Technical Monograph No. 2, 6^{th} Ed. May 2008, CropLife

International) are suspensions (e. g. SC, OD, FS), emulsifiable concentrates (e. g. EC), emulsions (e. g. EW, EO, ES, ME), capsules (e. g. CS, ZC), pastes, pastilles, wettable powders or dusts (e. g. WP, SP, WS, DP, DS), pressings (e. g. BR, TB, DT), granules (e. g. WG, SG, GR, FG, GG, MG), insecticidal articles (e. g. LN), as well as gel formulations for the treatment of plant propagation materials, such as seeds (e. g. GF). The compositions are prepared in a known manner, such as described by Mollet and Grubemann, Formulation technology, Wiley VCH, Weinheim, 2001; or by Knowles, New developments in crop protection product formulation, Agrow Reports DS243, T&F Informa, London, 2005. The invention also relates to agrochemical compositions comprising an auxiliary and any one of the mixtures described above. Suitable auxiliaries are solvents, liquid carriers, solid carriers or fillers, surfactants, dispersants, emulsifiers, wetters, adjuvants, solubilizers, penetration enhancers, protective colloids, adhesion agents, thickeners, humectants, repellents, attractants, feeding stimulants, compatibilizers, bactericides, anti-freezing agents, anti-foaming agents, colorants, tackifiers, and binders. Suitable solvents and liquid carriers are water and organic solvents, such as mineral oil fractions of medium to high boiling point, e. g. kerosene, diesel oil; oils of vegetable or animal origin; aliphatic, cyclic and aromatic hydrocarbons, e. g. toluene, paraffin, tetrahydronaphthalene, and alkylated naphthalenes; alcohols, e. g. ethanol, propanol, butanol, benzyl alcohol, cyclohexanol, glycols; DMSO; ketones, e. g. cyclohexanone; esters, e. g. lactates, carbonates, fatty acid esters, gamma-butyrolactone; fatty acids; phosphonates; amines; amides, e. g. N-methyl pyrrolidone, fatty acid dimethyl amides; and mixtures thereof.

Suitable solid carriers or fillers are mineral earths, e. g. silicates, silica gels, talc, kaolins, limestone, lime, chalk, clays, dolomite, diatomaceous earth, bentonite, calcium sulfate, magnesium sulfate, magnesium oxide; polysaccharides, e. g. cellulose, starch; fertilizers, e. g. ammonium sulfate, ammonium phosphate, ammonium nitrate, ureas; products of vegetable origin, e. g. cereal meal, tree bark meal, wood meal, nutshell meal, and mixtures thereof.

Suitable surfactants are surface-active compounds, such as anionic, cationic, nonionic and amphoteric surfactants, block polymers, polyelectrolytes, and mixtures thereof. Such surfactants can be used as emulsifier, dispersant, solubilizer, wetter, penetration enhancer, protective colloid, or adjuvant. Examples of surfactants are listed in McCutcheon's, Vol.1: Emulsifiers & Detergents, McCutcheon's Directories, Glen Rock, USA, 2008 (International Ed. or North American Ed.)

Suitable anionic surfactants are alkali, alkaline earth or ammonium salts of sulfonates, sulfates, phosphates, carboxylates, and mixtures thereof. Examples of sulfonates are alkylaryl sulfonates, diphenyl sulfonates, alpha-olefin sulfonates, lignin sulfonates, sulfonates of fatty acids and oils, sulfonates of ethoxylated alkylphenols, sulfonates of alkoxylated arylphenols, sulfonates of condensed naphthalenes, sulfonates of dodecyl- and tridecylbenzenes, sulfonates of naphthalenes and of alkylnaphthalenes, sulfosuccinates, or sulfosuccinamates. Examples of sulfates are sulfates of fatty acids, of oils, of ethoxylated alkylphenols, of alcohols, of ethoxylated alcohols, or of fatty acid esters. Examples of phosphates are phosphate esters. Examples of carboxylates are alkyl carboxylates, and carboxylated alcohol or alkylphenol ethoxylates. Suitable nonionic surfactants are alkoxylates, N-substituted fatty acid amides, amine oxides, esters, sugar-based surfactants, polymeric surfactants, and mixtures thereof. Examples of alkoxylates are compounds such as alcohols, alkylphenols, amines, amides, arylphenols, fatty acids or fatty acid esters which have been alkoxylated with 1 to 50 equivalents. Ethylene oxide and/or propylene oxide may be employed for the alkoxylation, preferably ethylene oxide. Examples of N-substituted fatty acid amides are fatty acid glucamides or fatty acid alkanolamides. Examples of esters are fatty acid esters, glycerol esters, or monoglycerides. Examples of sugar-based surfactants are sorbitans, ethoxylated sorbitans, sucrose and glucose esters, or alkylpolyglucosides. Examples of polymeric surfactants are home- or copolymers of vinyl pyrrolidone, vinyl alcohols, or vinyl acetate.

Suitable cationic surfactants are quaternary surfactants, for example quaternary ammonium compounds with one or two hydrophobic groups, or salts of long-chain primary amines. Suitable amphoteric surfactants are alkylbetains and imidazolines. Suitable block polymers are block polymers of the A-B or A-B-A type comprising blocks of polyethylene oxide and polypropylene oxide, or of the A-B-C type comprising alkanol, polyethylene oxide, and polypropylene oxide. Suitable polyelectrolytes are polyacids or polybases. Examples of polyacids are alkali salts of polyacrylic acid or polyacid comb polymers. Examples of polybases are polyvinyl amines or polyethylene amines.

Suitable adjuvants are compounds, which have a negligible or even no pesticidal activity themselves, and which improve the biological performance of the compound I on the target. Examples are surfactants, mineral or vegetable oils, and other auxiliaries. Further examples are listed by Knowles, Adjuvants and additives, Agrow Reports DS256, T&F Informa UK, 2006, chapter 5. Suitable thickeners are polysaccharides (e. g. xanthan gum, carboxymethyl cellulose), inorganic clays (organically modified or unmodified), polycarboxylates, and silicates.

Suitable bactericides are bronopol and isothiazolinone derivatives, such as alkylisothiazolinones and benzisothiazolinones.

Suitable anti-freezing agents are ethylene glycol, propylene glycol, urea and glycerin.

Suitable anti-foaming agents are silicones, long chain alcohols, and salts of fatty acids.

Suitable colorants (e. g. in red, blue, or green) are pigments of low water solubility and water-soluble dyes. Examples are inorganic colorants (e. g. iron oxide, titan oxide, iron hexacyanoferrate) and organic colorants (e. g. alizarin-, azo- and phthalocyanine colorants).

Suitable tackifiers or binders are polyvinyl pyrrolidones, polyvinyl acetates, polyvinyl alcohols, polyacrylates, biological or synthetic waxes, and cellulose ethers.

The agrochemical compositions generally comprise between 0.01 and 95%, preferably between 0.1 and 90%, more preferably between 1 and 70%, and in particular between 10 and 60%, by weight of the mixtures. In case component 1 is accompanied by or provided via cells or spores of fusaricidin producing Paenibacillus strains, the amount of these cells or spores is preferably between 5% w/w and 50% w/w, 10% w/w and 50% w/w, 15% w/w and 50% w/w, 30% w/w and 50% w/w, or 40% w/w and 50% w/w, or between 5% w/w and 40% w/w, 10% w/w and 40% w/w, 15% w/w and 40% w/w, 30% w/w and 40% w/w, or between 10% w/w and 40% w/w, 15% w/w and 40% w/w, 30% w/w and 40% w/w of the agrochemical composition.

The cells or spores of the fusaricidin producing Paenibacillus strains are usually present in the form of solid particles having an average particle size of 1 to 150 μm, or in an increased order of preference of 1 to 100 μm, 1 to 75 μm, 1 to 50 μm, 1 to 25 μm, 1 to 10 μm, or 1 to 8 μm (determined according to light scattering method in liquid dispersion according to CIPAC method 187).

The density number of spores per ml can be determined by identifying the number of colonyforming units (CFU) on agar medium e. g. potato dextrose agar after incubation for several days at temperatures of about 20 to about 35° C. The amount of CFU/g of biomass used to prepare agrochemical compositions of the invention are usually between 1×10⁸ CFU/g to 1×10¹¹ CFU/g, or 1×10⁸ CFU/g to 1×10¹⁰ CFU/g, or 5×10⁸ to 5×10¹⁰ CFU/g, preferably between 1×10⁹ CFU/g to 1×10¹⁰ CFU/g. The CFU/g of biomass will influence the amount of biomass which is used to prepare the formulations of the invention. Biomass having a comparatively high amount of CFU/g can be used to prepare formulations having a comparatively low amount of biomass. The amount of biomass used for preparing the formulations of the invention is usually selected to fit the amount of CFU per hectare, which should be applied for the respective purpose.

The total amount of fusaricidin A and fusaricidin B per gram of cells or spores of the fusaricidin producing Paenibacillus strains depend on the particular Paenibacillus strains and the growth conditions selected to produce the cells or spores. A skilled person will be able to use standard methods to determine the total amount of fusaricidin A and fusaricidin B per gram of cells or spores of the particular strain used and will be able to adjust the amount of gram cells or spores, if applicable also the amount of gram cells or spores and other fermentation solids, to determine how much of cells of spores and fermentation solids should be used in the mixtures to achieve a synergistic fungicidal effect with the amount of fungicide used.

The agrochemical compositions generally comprise between 5 and 99.9%, preferably between 10 and 99.9%, more preferably between 30 and 99%, and in particular between 40 and 90%, by weight of at least one auxiliary. The active substances, in particular the fungicides of component 2 and component 3, if applicable, are employed in a purity of from 90% to 100%, preferably from 95-% to 100% (according to NMR spectrum).

For the purposes of treatment of plant propagation materials, particularly seeds, solutions for seed treatment (LS), Suspoemulsions (SE), flowable concentrates (FS), powders for dry treatment (DS), water-dispersible powders for slurry treatment (WS), water-soluble powders (SS), emulsions (ES), emulsifiable concentrates (EC), and gels (GF) are usually employed. The compositions in question give, after two-to-tenfold dilution, active substance concentrations of from 0.01 to 60% by weight, preferably from 0.1 to 40%, in the ready-to-use preparations. Application can be carried out before or during sowing. Methods for applying the mixtures or agrochemical compositions comprising the mixtures, respectively, onto young plants and propagation material like seedlings, rooted/unrooted cuttings, plants derived from cell-culture, include dressing, coating, pelleting, dusting, soaking, as well as in-furrow application methods. Preferably, the mixtures and agrochemical compositions thereof, respectively, are applied on to seeds by a method such that germination is not induced, e. g. by seed dressing, pelleting, coating, and dusting.

Various types of oils, wetters, adjuvants, fertilizers, or micronutrients, and further pesticides (e. g. fungicides, growth regulators, herbicides, insecticides, safeners) may be added to the mixtures or the agrochemical compositions thereof as premix, or, not until immediately prior to use (tank mix). These agents can be admixed with the mixtures or the agrochemical compositions according to the invention in a weight ratio of 1:100 to 100:1, preferably 1:10 to 10:1.

The mixtures and compositions are usually applied in an pesticidally effective amount. In general, “pesticidally effective amount” means the amount of the mixtures or of the agrochemical compositions comprising the mixtures needed to achieve an observable effect on growth, including the effects of necrosis, death, retardation, prevention, and removal, destruction, or otherwise diminishing the occurrence and activity of the target organism. The pesticidally effective amount can vary for the various mixtures / compositions used in the invention. A pesticidally effective amount of the mixtures / compositions will also vary according to the prevailing conditions such as desired pesticidal effect and duration, weather, target species, locus, mode of application, and the like.

When the mixtures or agrochemical compositions are used to be applied as foliar treatment or to the soil, preferably as foliar treatment. The application rates in foliar treatments are usually between 50 g/ha and 2000 g/ha, 100 g/ha and 2000 g/ha, 150 g/ha and 2000 g/ha, 600 g/ha and 2000 g/ha or 800 g/ha and 2000 g/ha or

between 50 g/ha and 1000 g/ha, 100 g/ha and 1000 g/ha, 150 g/ha and 1000 g/ha, 600 g/ha and 1000 g/ha or 800 g/ha and 1000 g/ha,

or between 50 g/ha and 800 g/ha, 100 g/ha and 800 g/ha, 150 g/ha and 800 g/ha, 600 g/ha and 800 g/ha or

between 150 g/ha and 1000 g/ha, 300 g/ha and 1000 g/ha, 600 g/ha and 1000 g/ha of fusaricidin comprising cells or spores in a volume

between 1000 L/ha and 100L/ha, 600 L/ha and 100L/ha, 400 L/ha and 100L/ha, 200L/ha and 100L/ha or

between 1000 L/ha and 600 L/ha, 1000 L/ha and 400 L/ha or 1000 L/ha and 200L/ha, or between 600 L/ha and 200L/ha, 600 L/ha and 400 L/ha of a water based spraying liquid.

When the formulations of the invention are employed in seed treatment, the application rates with respect to plant propagation material usually range from about 1×10¹ to 1×10¹² (or more) CFU/seed, preferably from about 1×10³ to about 1×10¹⁰ CFU/seed, and even more preferably from about 1×10³ to about 1×10⁶ CFU/seed. Alternatively, the application rates with respect to plant propagation material preferably range from about 1×10⁷ to 1×10¹⁶ (or more) CFU per 100 kg of seed, preferably from 1×10⁹ to about 1×10¹⁵ CFU per 100 kg of seed, even more preferably from 1×10¹¹ to about 1×10¹⁵ CFU per 100 kg of seed.

The mixtures have antifungal effects and are useful in methods of suppressing or preventing fungal infection of plants.

The mixtures are employed as such or in form of agrochemical compositions by treating the fungi, the plants, young plants like seedlings, rooted/unrooted cuttings, plants derived from cell-culture or plant propagation materials, such as seeds; soil, surfaces, materials, or rooms to be protected from fungal attack with a fungicidally effective amount of the active substances. The application can be carried out both before and after the infection of the plants, plant propagation materials, such as seeds; soil, surfaces, materials or rooms by the fungi.

An agrochemical composition comprises a fungicidally effective amount of the mixtures. The term “fungicidally effective amount” denotes an amount of the composition or of the mixtures, which is sufficient for controlling harmful fungi plants and which does not result in a substantial damage to the treated plants, young plants like seedlings, rooted/unrooted cuttings, plants derived from cell-culture or plant propagation materials, such as seeds. Such an amount can vary in a broad range and is dependent on various factors, such as the fungal species to be controlled, the treated plant species, the climatic conditions and the specific mixture used.

Plant propagation materials may be treated with mixtures as such or a composition or a mixture prophylactically either at or before planting or transplanting.

When employed in plant protection, the total amounts of component 1, component 2 and optional component 3, of the mixtures applied are, depending on the kind of effect desired, from 0.001 to 2 kg per ha, preferably from 0.005 to 2 kg per ha, more preferably from 0.05 to 0.9 kg per ha, and in particular from 0.1 to 0.75 kg per ha.

In treatment of plant propagation materials, such as seeds, e. g. by dusting, coating, or drenching, amounts of active substances of the mixtures generally from 0.1 to 1000 g, preferably from 1 to 1000 g, more preferably from 1 to 100 g and most preferably from 5 to 100 g, per 100 kg of plant propagation material (preferably seeds) are required.

The user applies the agrochemical composition usually from a predosage device, a knapsack sprayer, a spray tank, a spray plane, or an irrigation system. Usually, the agrochemical composition is made up with water, buffer, and/or further auxiliaries to the desired application concentration and the ready-to-use spraying liquid or the agrochemical composition according to the invention is thus obtained. Usually, 20 to 2000 liters, preferably 50 to 400 liters, of the ready-to-use spray liquor are applied per hectare of agricultural useful area.

The mixtures and the agrochemical compositions thereof, respectively, are suitable as fungicides effective against a broad spectrum of phytopathogenic fungi, including soil-borne fungi, in particular from the classes of Plasmodiophoromycetes, Peronosporomycetes (syn. Oomycetes), Chytridiomycetes, Zygomycetes, Ascomycetes, Basidiomycetes, and Deuteromycetes (syn. Fungi imperfecti). They can be used in crop protection as foliar fungicides, fungicides for seed dressing, and soil fungicides.

The mixtures and the agrochemical compositions thereof are preferably useful in the control of phytopathogenic fungi on various cultivated plants, such as cereals, e. g. wheat, rye, barley, triticale, oats, or rice; beet, e. g. sugar beet or fodder beet; fruits, e. g. pomes (apples, pears, etc.), stone fruits (e.g. plums, peaches, almonds, cherries), or soft fruits, also called berries (strawberries, raspberries, blackberries, gooseberries, etc.); leguminous plants, e. g. lentils, peas, alfalfa, or soybeans; oil plants, e. g. oilseed rape, mustard, olives, sunflowers, coconut, cocoa beans, castor oil plants, oil palms, ground nuts, or soybeans; cucurbits, e. g. squashes, cucumber, or melons; fiber plants, e. g. cotton, flax, hemp, or jute; citrus fruits, e. g. oranges, lemons, grapefruits, or mandarins; vegetables, e. g. spinach, lettuce, asparagus, cabbages, carrots, onions, tomatoes, potatoes, cucurbits, or paprika; lauraceous plants, e. g. avocados, cinnamon, or camphor; energy and raw material plants, e. g. corn, soybean, oilseed rape, sugar cane, or oil palm; corn; tobacco; nuts; coffee; tea; bananas; vines (table grapes and grape juice grape vines); hop; turf; sweet leaf (also called Stevia); natural rubber plants; or ornamental and forestry plants, e. g. flowers, shrubs, broad-leaved trees, or evergreens (conifers, eucalypts, etc.); on the plant propagation material, such as seeds; and on the crop material of these plants.

More preferably, the mixtures and the agrochemical compositions thereof, respectively, are used for controlling fungi on field crops, such as potatoes, sugar beets, tobacco, wheat, rye, barley, oats, rice, corn, cotton, soybeans, oilseed rape, legumes, sunflowers, coffee or sugar cane; fruits; vines; grapes for wine making or fruit grapes, ornamentals; or vegetables, such as cucumbers, tomatoes, pepper, beans or squashes.

The term “plant propagation material” is to be understood to denote all the generative parts of the plant, such as seeds; and vegetative plant materials, such as cuttings and tubers (e. g. potatoes), which can be used for the multiplication of the plant. This includes seeds, roots, fruits, tubers, bulbs, rhizomes, shoots, sprouts and other parts of plants; including seedlings and young plants to be transplanted after germination or after emergence from soil.

Accordingly, one embodiment of the invention is plant propagation material comprising the mixtures or comprising a coating of an agrochemical composition comprising the mixtures. Preferably the plant propagation material are young plants, like seedlings, rooted/unrooted cuttings, plants derived from cell-culture. Even more preferred the plant propagation material is from fruit or vegetable plant species, including grapes.

According to the invention all of the above cultivated plants are understood to comprise all species, subspecies, variants and/or hybrids which belong to the respective cultivated plants. For example, corn is also known as Indian corn or maize (Zea mays) which comprises all kinds of corn such as field corn and sweet corn. According to the invention all maize or corn subspecies and/or varieties are comprised, in particular flour corn (Zea mays var. amylacea), popcorn (Zea mays var. everta), dent corn (Zea mays var. indentata), flint corn (Zea mays var. indurata), sweet corn (Zea mays var. saccharata and var. rugosa), waxy corn (Zea mays var. ceratina), amylomaize (high amylose Zea mays varieties), pod corn or wild maize (Zea mays var. tunicata) and striped maize (Zea mays var. japonica). The skilled person knows similar variants of other plant species, like, sweet pepper, determinate or indeterminate soybean, and others.

The mixtures and the agrochemical compositions thereof, respectively, are particularly suitable for controlling the following causal agents of plant diseases:

Albugo spp. (white rust) on ornamentals, vegetables (e. g. A. candida) and sunflowers (e. g. A. tragopogonis); Alternaria spp. (Alternaria leaf spot) on vegetables (e.g. A. dauci or A. porri), oilseed rape (A. brassicicola or brassicae), sugar beets (A. tenuis), fruits (e.g. A. grandis), rice, soybeans, potatoes and tomatoes (e. g. A. solani, A. grandis or A. alternata), tomatoes (e. g. A. solani or A. alternata) and wheat (e.g. A. triticina); Aphanomyces spp. on sugar beets and vegetables; Ascochyta spp. on cereals and vegetables, e. g. A. tritici (anthracnose) on wheat and A. hordei on barley; Aureobasidium zeae (syn. Kapatiella zeae) on corn; Bipolaris and Drechslera spp. (teleomorph: Cochliobolus spp.), e. g. Southern leaf blight (D. maydis) or Northern leaf blight (B. zeicola) on corn, e. g. spot blotch (B. sorokiniana) on cereals and e. g. B. oryzae on rice and turfs; Blumeria (formerly Erysiphe) graminis (powdery mildew) on cereals (e. g. on wheat or barley); Botrytis cinerea (teleomorph: Botryotinia fuckeliana: grey mold) on fruits and berries (e. g. strawberries), vegetables (e. g. lettuce, carrots, celery and cabbages); B. squamosa or B. allii on onion family), oilseed rape, ornamentals (e.g. B eliptica), vines, forestry plants and wheat; Bremia lactucae (downy mildew) on lettuce; Ceratocystis (syn. Ophiostoma) spp. (rot or wilt) on broad-leaved trees and evergreens, e. g. C. ulmi (Dutch elm disease) on elms; Cercospora spp. (Cercospora leaf spots) on corn (e. g. Gray leaf spot: C. zeae-maydis), rice, sugar beets (e. g. C. beticola), sugar cane, vegetables, coffee, soybeans (e. g. C. sojina or C. kikuchii) and rice; Cladobotryum (syn. Dactylium) spp. (e.g. C. mycophilum (formerly Dactylium dendroides, teleomorph: Nectria albertinii, Nectria rosella syn. Hypomyces rosellus) on mushrooms; Cladosporium spp. on tomatoes (e. g. C. fulvum: leaf mold) and cereals, e. g. C. herbarum (black ear) on wheat; Claviceps purpurea (ergot) on cereals; Cochliobolus (anamorph: Helminthosporium of Bipolaris) spp. (leaf spots) on corn (C. carbonum), cereals (e. g. C. sativus, anamorph: B. sorokiniana) and rice (e. g. C. miyabeanus, anamorph: H. oryzae); Colletotrichum (teleomorph: Glomerella) spp. (anthracnose) on cotton (e. g. C. gossypii), corn (e. g. C. graminicola: Anthracnose stalk rot), soft fruits, potatoes (e. g. C. coccodes: black dot), beans (e. g. C. lindemuthianum), soybeans (e. g. C. truncatum or C. gloeosporioides), vegetables (e.g. C. lagenarium or C. capsid), fruits (e.g. C. acutatum), coffee (e.g. C. coffeanum or C. kahawae) and C. gloeosporioides on various crops; Corticium spp., e. g. C. sasakii (sheath blight) on rice; Corynespora cassiicola (leaf spots) on soybeans, cotton and ornamentals; Cycloconium spp., e. g. C. oleaginum on olive trees; Cylindrocarpon spp. (e. g. fruit tree canker or young vine decline, teleomorph: Nectria or Neonectria spp.) on fruit trees, vines (e. g. C. liriodendri, teleomorph: Neonectria liriodendri: Black Foot Disease) and ornamentals; Dematophora (teleomorph: Rosellinia) necatrix (root and stem rot) on soybeans; Diaporthe spp., e. g. D. phaseolorum (damping off) on soybeans; Drechslera (syn. Helminthosporium, teleomorph: Pyrenophora) spp. on corn, cereals, such as barley (e. g. D. teres, net blotch) and wheat (e. g. D. tritici-repentis: tan spot), rice and turf; Esca (dieback, apoplexy) on vines, caused by Formitiporia (syn. Phellinus) punctata, F. mediterranea, Phaeomoniella chlamydospora (formerly Phaeoacremonium chlamydosporum), Phaeoacremonium aleophilum and/or Botryosphaeria obtusa; Elsinoe spp. on pome fruits (E. pyri), soft fruits (E. veneta: anthracnose) and vines (E. ampelina: anthracnose); Entyloma oryzae (leaf smut) on rice; Epicoccum spp. (black mold) on wheat; Erysiphe spp. (powdery mildew) on sugar beets (E. betae), vegetables (e. g. E. pisi), such as cucurbits (e. g. E. cichoracearum), cabbages, oilseed rape (e. g. E. cruciferarum); Eutypa lata (Eutypa canker or dieback, anamorph: Cytosporina lata, syn. Libertella blepharis) on fruit trees, vines and ornamental woods; Exserohilum (syn. Helminthosporium) spp. on corn (e. g. E. turcicum); Fusarium (teleomorph: Gibberella) spp. (wilt, root or stem rot) on various plants, such as F. graminearum or F. culmorum (root rot, scab or head blight) on cereals (e. g. wheat or barley), F. oxysporum on tomatoes, F. solani (F. sp. glycines now syn. F. virguliforme) and F. tucumaniae and F. brasiliense each causing sudden death syndrome on soybeans, and F. verticillioides on corn; Gaeumannomyces graminis (take-all) on cereals (e. g. wheat or barley) and corn; Gibberella spp. on cereals (e. g. G. zeae) and rice (e. g. G. fujikuroi: Bakanae disease); Glomerella cingulata on vines, pome fruits and other plants and G. gossypii on cotton; Grain-staining complex on rice; Guignardia bidwellii (black rot) on vines; Gymnosporangium spp. on rosaceous plants and junipers, e. g. G. sabinae (rust) on pears; Helminthosporium spp. (syn. Drechslera, teleomorph: Cochliobolus) on corn, cereals, potatoes and rice; Hemileia spp., e. g. H. vastatrix (coffee leaf rust) on coffee; Isariopsis clavispora (syn. Cladosporium vitis) on vines; Macrophomina phaseolina (syn. phaseoli) (root and stem rot) on soybeans and cotton; Microdochium (syn. Fusarium) nivale (pink snow mold) on cereals (e. g. wheat or barley); Microsphaera diffusa (powdery mildew) on soybeans; Monilinia spp., e. g. M. laxa, M. fructicola and M. fructigena (syn. Monilia spp.: bloom and twig blight, brown rot) on stone fruits and other rosaceous plants; Mycosphaerella spp. on cereals, bananas, soft fruits and ground nuts, such as e. g. M. graminicola (anamorph: Zymoseptoria tritici formerly Septoria tritici: Septoria blotch) on wheat or M. fijiensis (syn. Pseudocercospora fijiensis: black Sigatoka disease) and M. musicola on bananas, M. arachidicola (syn. M. arachidis or Cercospora arachidis), M. berkeleyi on peanuts, M. pisi on peas and M. brassiciola on brassicas; Peronospora spp. (downy mildew) on cabbage (e. g. P. brassicae), oilseed rape (e. g. P. parasitica), onions (e. g. P. destructor), tobacco (P. tabacina) and soybeans (e. g. P. manshurica); Phakopsora pachyrhizi and P. meibomiae (soybean rust) on soybeans; Phialophora spp. e. g. on vines (e. g. P. tracheiphila and P. tetraspora) and soybeans (e. g. P. gregata: stem rot); Phoma lingam (syn. Leptosphaeria biglobosa and L. maculans: root and stem rot) on oilseed rape and cabbage, P. betae (root rot, leaf spot and damping-off) on sugar beets and P. zeae-maydis (syn. Phyllostica zeae) on corn; Phomopsis spp. on sunflowers, vines (e. g. P. viticola: can and leaf spot) and soybeans (e. g. stem rot: P. phaseoli, teleomorph: Diaporthe phaseolorum); Physoderma maydis (brown spots) on corn; Phytophthora spp. (wilt, root, leaf, fruit and stem root) on various plants, such as paprika and cucurbits (e. g. P. capsid), soybeans (e. g. P. megasperma, syn. P. sojae), potatoes and tomatoes (e. g. P. infestans: late blight) and broad-leaved trees (e. g. P. ramorum: sudden oak death); Plasmodiophora brassicae (club root) on cabbage, oilseed rape, radish and other plants; Plasmopara spp., e. g. P. viticola (grapevine downy mildew) on vines and P. halstedii on sunflowers; Podosphaera spp. (powdery mildew) on rosaceous plants, hop, pome and soft fruits (e. g. P. leucotricha on apples) and curcurbits (P. xanthii); Polymyxa spp., e. g. on cereals, such as barley and wheat (P. graminis) and sugar beets (P. betae) and thereby transmitted viral diseases; Pseudocercosporella herpotrichoides (syn. Oculimacula yallundae, O. acuformis: eye-spot, teleomorph: Tapesia yallundae) on cereals, e. g. wheat or barley; Pseudoperonospora (downy mildew) on various plants, e. g. P. cubensis on cucurbits or P. humili on hop; Pseudopezicula tracheiphila (red fire disease or ,rotbrenner’, anamorph: Phialophora) on vines; Puccinia spp. (rusts) on various plants, e. g. P. triticina (brown or leaf rust), P. striiformis (stripe or yellow rust), P. hordei (dwarf rust), P. graminis (stem or black rust) or P. recondita (brown or leaf rust) on cereals, such as e. g. wheat, barley or rye, P. kuehnii (orange rust) on sugar cane and P. asparagi on asparagus; Pyrenopeziza spp., e.g. P. brassicae on oilseed rape; Pyrenophora (anamorph: Drechslera) tritici-repentis (tan spot) on wheat or P. teres (net blotch) on barley; Pyricularia spp., e. g. P. oryzae (teleomorph: Magnaporthe grisea: rice blast) on rice and P. grisea on turf and cereals; Pythium spp. (damping-off) on turf, rice, corn, wheat, cotton, oilseed rape, sunflowers, soybeans, sugar beets, vegetables and various other plants (e. g. P. ultimum or P. aphanidermatum) and P. oligandrum on mushrooms; Ramularia spp., e. g. R. collo-cygni (Ramularia leaf spots, Physiological leaf spots) on barley, R. areola (teleomorph: Mycosphaerella areola) on cotton and R. beticola on sugar beets; Rhizoctonia spp. on cotton, rice, potatoes, turf, corn, oilseed rape, potatoes, sugar beets, vegetables and various other plants, e. g. R. solani (root and stem rot) on soybeans, R. solani (sheath blight) on rice or R. cerealis (Rhizoctonia spring blight) on wheat or barley; Rhizopus stolonifer (black mold, soft rot) on strawberries, carrots, cabbage, vines and tomatoes; Rhynchosporium secalis and R. commune (scald) on barley, rye and triticale; Sarocladium oryzae and S. attenuatum (sheath rot) on rice; Sclerotinia spp. (stem rot or white mold) on vegetables (S. minor and S. sclerotiorum) and field crops, such as oilseed rape, sunflowers (e.g. S. sclerotiorum) and soybeans, S. rolfsii (syn. Athelia rolfsii) on soybeans, peanut, vegetables, corn, cereals and ornamentals; Septoria spp. on various plants, e.g. S. glycines (brown spot) on soybeans, S. tritici (syn. Zymoseptoria tritici, Septoria blotch) on wheat and S. (syn. Stagonospora) nodorum (Stagonospora blotch) on cereals; Uncinula (syn. Erysiphe) necator (powdery mildew, anamorph: Oidium tuckeri) on vines; Setosphaeria spp. (leaf blight) on corn (e.g. S. turcicum, syn. Helminthosporium turcicum) and turf; Sphacelotheca spp. (smut) on corn, (e.g. S. reiliana, syn. Ustilago reiliana: head smut), sorghum and sugar cane; Sphaerotheca fuliginea (syn. Podosphaera xanthii: powdery mildew) on cucurbits; Spongospora subterranea (powdery scab) on potatoes and thereby transmitted viral diseases; Stagonospora spp. on cereals, e.g. S. nodorum (Stagonospora blotch, teleomorph: Leptosphaeria [syn. Phaeosphaeria] nodorum, syn. Septoria nodorum) on wheat; Synchytrium endobioticum on potatoes (potato wart disease); Taphrina spp., e. g. T. deformans (leaf curl disease) on peaches and T. pruni (plum pocket) on plums; Thielaviopsis spp. (black root rot) on tobacco, pome fruits, vegetables, soybeans and cotton, e.g. T. basicola (syn. Chalara elegans); Tilletia spp. (common bunt or stinking smut) on cereals, such as e. g. T. tritici (syn. T. caries, wheat bunt) and T. controversa (dwarf bunt) on wheat; Trichoderma harzianum on mushrooms; Typhula incarnata (grey snow mold) on barley or wheat; Urocystis spp., e.g. U. occulta (stem smut) on rye; Uromyces spp. (rust) on vegetables, such as beans (e.g. U. appendiculatus, syn. U. phaseoli), sugar beets (e.g. U. betae or U. beticola) and on pulses (e.g. U. vignae, U. pisi, U. viciae-fabae and U. fabae); Ustilago spp. (loose smut) on cereals (e.g. U. nuda and U. avaenae), corn (e.g. U. maydis: corn smut) and sugar cane; Venturia spp. (scab) on apples (e.g. V. inaequalis) and pears; and Verticillium spp. (wilt) on various plants, such as fruits and ornamentals, vines, soft fruits, vegetables and field crops, e.g. V. longisporum on oilseed rape, V. dahliae on strawberries, oilseed rape, potatoes and tomatoes, and V. fungicola on mushrooms; Zymoseptoria tritici on cereals.

The mixtures and the agrochemical compositions thereof, respectively, are particularly suitable for controlling the following phytophathogenic fungi genera; Alternaria, Botrytis, Venturia, Leptosphaeria, Fusarium, Rhizoctonia, Phytophthora, Pythium, Colletotrichum, Pyricularia, Sclerotinia, Zymoseptoria.

The mixtures and the agrochemical compositions thereof, respectively, are particularly suitable for controlling the following phytophathogenic fungi, Alternaria solanum, Alternaria altemata, Alternaria brassicae, Alternaria brassicicola, Alternaria citri, Alternaria mali, Botrytis cinerea, Bottytis allii, Bottytis fabae, Bottytis squamosa, Venturia inaequalis, Venturia effusa, Venturia carpophila, Venturia pyrina, Leptosphaeria maculans, Leptosphaeria nodorum Fusarium oxysporum, Fusarium graminearum, Fusarium verticillioides, Rhizoctonia solani, Phytophthora infestans, Phytophthora capsici, Phytophthora fragariae, Phytophthora nicotianae, Phytophthora sojae, Pythium ultimum, Pythium acanthicum, Pythium deliense, Pythium graminicola, Pythium heterothallicum, Pythium hypogynum, Pythium middletonii Colletotrichum orbiculare, Colletotrichum capsici, Colletotrichum coccodes, Colletotrichum fragariae, Colletotrichum lindemuthianum, Pyricularia oryzae, Sclerotinia sclerotiorum, Sclerotinia minor, Sclerotinia trifoliorum, Zymoseptoria tritici.

The mixtures and the agrochemical compositions thereof, respectively, are particularly suitable for controlling the following phytophathogenic fungi, Alternaria solanum, Botrytis cinerea, Venturia inaequalis, Leptosphaeria maculans, Leptosphaeria nodorum, Fusarium oxysporum, Fusarium graminearum, Rhizoctonia solani, Phytophthora infestans, Pythium ultimum, Colletotrichum orbiculare, Pyricularia oryzae, Sclerotinia sclerotiorum and Zymoseptoria tritici.

The mixtures and the agrochemical compositions thereof, respectively, are particularly suitable for controlling the following phytophathogenic fungi, Alternaria solanum, Botrytis cinerea, Leptosphaeria nodorum, Phytophthora infestans, Colletotrichum orbiculare, Pyricularia oryzae, Sclerotinia sclerotiorum and Zymoseptoria tritici.

The mixtures described in detail above are particularly suited to be used in a method for suppressing or preventing fungal infection of plants.

Accordingly, one embodiment of the invention is a method for suppressing or preventing fungal infection of plants, using any one of the mixtures described above in which the plants, parts of plants or the soil close to the plant is treated with such a mixture. The mixture can be applied as a mixture or created by applying component 1 and component 2, and if applicable component 3, separately to the plant, the plant parts or the soil close to the plant to create the mixture at the plant, the plant parts or the soil close to the plant.

Thus, the invention comprises a method for suppressing or preventing fungal infection of plants, characterised in that a mixture of fusaricidin A and fusaricidin B is applied to the plants, parts of plants or the soil close to the plant in combination with at least one fungicide selected from the group comprising difenoconazole, prothioconazol, mefentrifluconazol, metconazole, triticonazol, difenoconazol, triadimenol, prochloraz, tebuconazol, epoxiconazol, ipconazol, metalaxyl-M, mefenoxam, spiroxamine, fludioxonil, penflufen, bixafen, fluxapyroxad, boscalid, benzovindiflupyr, fluopyram, penthiopyrad, sedaxan, fluoxastrobin, metyltetraprole, azoxystrobin, trifloxystrobin, pyraclostrobin, dimoxystrobin, picoxystrobin, orysastrobin, cyazofamid, amisulbrom, thiabendazole, thiophanatemethyl, zoxamide, ethaboxam, cymoxanil, picarbutrazox, fluazinam, valifenalate, benthiavalicarb, iprovalicarb, mandipropamid, dimethomorph, fluopicolide, ametoctradin, silthiofam oxathiapiprolin, pyriofenone, metrafenone, metiram, mancozeb, thiram, dithianon, fosetyl and fosetyl-aluminium,

preferably selected from the group comprising difenoconazole, spiroxamine, fluxapyroxad, boscalid, fluindapyr, isoflucypram, inpyrfluxam, pydiflumetofen, pyrimethanil, fluoxastrobin, metyltetraprole, trifloxystrobin, cyazofamid, amisulbrom, zoxamide, cymoxanil, fluazinam, valifenalate, benthiavalicarb, iprovalicarb, mandipropamid, dimethomorph, fluopicolide, ametoctradin, oxathiapiprolin, pyriofenone, metrafenone, metiram, mancozeb, dithianon, fosetyl and fosetyl-Al,

more preferred selected from the group comprising spiroxamine, boscalid, fluoxastrobin, metyltetraprole, trifloxystrobin, cyazofamid, amisulbrom, zoxamide, cymoxanil, fluazinam, valifenalate, benthiavalicarb, iprovalicarb, mandipropamid, fluopicolide, ametoctradin, oxathiapiprolin, pyriofenone, metrafenone, metiram, mancozeb, dithianon, fosetyl and fosetyl-aluminium (fosetyl-Al),

wherein the at least one fungicide is applied

a) in a mixture with fusaricidin A and fusaricidin B, or

b) not more than ten, nine, eight, seven, six, five, four, three, two, one days before application of a mixture of fusaricidin A and fusaricidin B, or

c) not more than five, four, three, two, one days after the application of a mixture of fusaricidin A and fusaricidin B, or

d) on the same day as the application of fusaricidin A and fusaricidin B.

A further embodiment of the invention is a method for suppressing or preventing fungal infection of plants, characterised in that a mixture of fusaricidin A and fusaricidin B is applied to the plant in combination with at least one fungicide selected from the group comprising: difenoconazole, spiroxamine, fluxapyroxad, boscalid, fluindapyr, isoflucypram, inpyrfluxam, pydiflumetofen, pyrimethanil, fluoxastrobin, metyltetraprole, trifloxystrobin, cyazofamid, amisulbrom, zoxamide, cymoxanil, fluazinam, valifenalate, benthiavalicarb, iprovalicarb, mandipropamid, dimethomorph, fluopicolide, ametoctradin, oxathiapiprolin, pyriofenone, metrafenone, metiram, mancozeb, dithianon, fosetyl and fosetyl-Al,

preferably selected from the group comprising: spiroxamine, boscalid, fluoxastrobin, metyltetraprole, trifloxystrobin, cyazofamid, amisulbrom, zoxamide, cymoxanil, fluazinam, valifenalate, benthiavalicarb, iprovali-carb, mandipropamid, fluopicolide, ametoctradin, oxathiapiprolin, pyriofenone, met-rafenone, metiram, mancozeb, dithianon, fosetyl and fosetyl-aluminium (fosetyl-Al),

wherein the at least one fungicide is applied

a) in a mixture with fusaricidin A and fusaricidin B, or

b) not more than ten, nine, eight, seven, six, five, four, three, two, one days before application of a mixture of fusaricidin A and fusaricidin B, or

c) not more than five, four, three, two, one days after the application of a mixture of fusaricidin A and fusaricidin B , or

d) on the same day as the application of fusaricidin A and fusaricidin B.

In one embodiment the at least one fungicide is applied to the plant in a mixture with fusaricidin A and fusaricidin B, or on the same day as the application of fusaricidin A and fusaricidin B.

In one embodiment the at least one fungicide is applied to the plant not more than ten, nine, eight, seven, six, five, four, three, two, one days before application of a mixture of fusaricidin A and fusaricidin B.

In one embodiment the at least one fungicide is applied to the plant not more than five, four, three, two, one days after the application of a mixture of fusaricidin A and fusaricidin B.

In one embodiment component 2 is bixafene, fluoxastrobine, trifloxystrobine, metyltetraprole, cyazofamide, amisulbrome, fluazi-name, iprovalicarbe, fluopicolide, metrafenone or mancozeb and is applied in a mixture with component 1, or on the same day as the application of component 1, or is applied not more than ten, nine, eight, seven, six, five, four, three, two, one days before application of component 1.

In one embodiment component 2 is spiroxamine, cymoxanile, benthiavalicarbe, oxathiapiproline, pyriofenone, metrafenone, zoxamide, metiram, boscalid, valifenalate, ametoctradin, dithianon, fosetyl, fosetyl-Al or mandipropamide and is applied in a mixture with component 1, or on the same day as the application of component 1, or is applied not more than five, four, three, two, one days before application of component 1.

In one embodiment the mixture of fusaricidin A and fusaricidin B is applied as isolated compounds, in alternative embodiments the mixture of fusaricidin A and fusaricidin B is applied together with spores or cells of one or more Paenibacillus strains either having produced the fusaricidin A and B or having the capacity to produce fusaricidin A and fusaricidin B. Preferably, the spores or cells belong to Paenibacillus polymyxa, Paenibacillus epiphyticus, Paenibacillus peoriae, Paenibacillus terrae, Paenibacillus jamilae and Paenibacillus kribbensis, preferably to the strains: P. polymyxa strain PKB1, P. polymyxa strain JB05-01-1, P. polymyxa strain AC-1,

P. polymyxa strain HY96-2, Paenibacillus sp. strains NRRL B-50972, NRRL B-67129, NRRL B-67304, NRRL B-67306 and NRRL B-67615, NRRL B-50374, NRRL B-67721, NRRL B-67723, NRRL B-67724, P. polymyxa strain VMC10/96, Paenibacillus sp. strain 10.6D and Paenibacillus sp. strain 9.4E, Paenibacillus sp. strains Lu16774, Lu17007 and Lu17015, P. polymyxa strain M1, P. polymyxa strain SC2 and P. polymyxa strain Sb3-1 and P. polymyxa strain E681.

In preferred embodiments of the method for suppressing or preventing fungal infection of plants, wherein the mixture component 1, component 2 and, if applicable, component 3 is applied at least once between
a) growth stage 56 to 89 for fruit and nut trees, preferably cherry, cherry, plum, peach, apricot, apple, almond and citrus, or
b) growth stage 56 to 85, preferred between growth stage 61 to 85, for berry fruits, preferably currants and strawberry, or
c) growth stage 61 to 89, preferred between growth stage 68 to 83, for grape vine, or
d) growth stage 41 to 49, preferred between growth stage 45 to 49, for head forming vegetables, preferably cabbage, or
e) growth stage 22 to 81, preferred between growth stage 61 to 81, for cucurbits, preferably cucumber, melons and pumpkins, or
f) growth stage 51 to 71, preferred between growth stage 61 to 71, for solanaceous vegetables, preferably tomato, eggplant, sweet pepper and chili pepper.

The growth stage number refers two digit code of growth stages defined in the extended BBCH-scale. The scale has been named after BBCH derives from the Biologische Bundesanstalt Bundessortenamt und Chemical Industry and has been published in Meier, Uwe: Growth stages of mono- and dicotyledonous plants. BBCH Monograph. Quedlinburg 2018. Open Agrar Repositorium DOI (10.5073/20180906-074619).

### EXAMPLES

The present invention will be described in greater detail by means of the following examples. The following examples are for illustrative purposes and are not intended to limit the scope of the invention.

### Microtests

The active compounds were formulated separately as a stock solution having a concentration of 10000 ppm in dimethyl sulfoxide.

The Fusaricidin used in the examples was a mixture of fusaricidin A and fusaricidin B in a ratio of 0.6 to 1 and have been purified from a culture of Paenibacillus strain derived from Paenibacillus strain 17007 by BASF. Paenibacillus strain 17007 has been disclosed in WO2016/020371 and has been isolated from crop acreage in Germany and deposited under the Budapest Treaty with the Deutsche Sammlung von Mikroorganismen und Zellkulturen (DSMZ) on Feb. 20, 2013 under Accession No. DSM 26969 by BASF SE.

The product oxathiapiproline was used as a commercial finished formulation and diluted with water to the stated concentration of the active compound.

The measured parameters were compared to the growth of the active compound-free control variant (100%) and the fungus-free blank value to determine the relative growth in % of the pathogens in the respective active compounds. These percentages were converted into efficacies.

An efficacy of 0 means that the growth level of the pathogens corresponds to that of the untreated control; an efficacy of 100 means that the pathogens were not growing.

The expected efficacies of active compound mixtures were determined using Colby's formula [R. S. Colby, “Calculating synergistic and antagonistic responses of herbicide combinations”, Weeds 15, 20-22 (1967)] and compared with the observed efficacies.

1. Activity Against Colletotrichum orbiculare in the Microtiterplate Test (COLLLA
1. The stock solutions were mixed according to the ratio, pipetted onto a micro titer plate (MTP) and diluted with water to the stated concentrations. A spore suspension of Colletotrichum orbiculare in an aqueous biomalt or yeast-bactopeptone-sodiumacetate solution was then added. The plates were placed in a water vapor-saturated chamber at a temperature of 18° C. Using an absorption photometer, the MTPs were measured at 405 nm 7 days after the inoculation.

### COLLLA

| | Active | Concentration | | | Calculated | |
|---|---|---|---|---|---|---|
| | compound/ | (ppm) | | | efficacy | |
| Compound | active | weight/ | | Observed | according to | Synergism |
| Group | mixture | weight | Mixture | efficacy | Colby (%) | (%) |
| | Fusaricidin | 1 | — | 0 | | |
| | | 0.25 | — | 1 | | |
| | | 0.063 | — | 0 | | |
| | | 0.016 | — | 0 | | |
| 1 | Dithianon | 0.063 | — | 0 | | |
| 1 | Methyltetraprol | 0.063 | — | 19 | | |
| 3 | Pyriofenon | 16 | — | 20 | | |
| 3 | Spiroxamin | 16 | — | 8 | | |
| 2 | Zoxamid | 1 | — | 0 | | |
| 1 | Fusaricidin | 0.063 | 1:1 | 46 | 0 | 46 |
| | Dithianon | 0.063 | | | | |
| 1 | Fusaricidin | 0.016 | 1:4 | 42 | 0 | 42 |
| | Dithianon | 0.063 | | | | |
| 1 | Fusaricidin | 0.25 | 4:1 | 24 | 1 | 23 |
| | Dithianon | 0.063 | | | | |
| 1 | Fusaricidin | 1 | 16:1 | 38 | 19 | 19 |
| | Methyltetraprol | 0.063 | | | | |
| 3 | Fusaricidin | 1 | 1:16 | 40 | 20 | 20 |
| | Pyriofenon | 16 | | | | |
| 3 | Fusaricidin | 1 | 1:16 | 33 | 8 | 25 |
| | Spiroxamin | 16 | | | | |
| 2 | Fusaricidin | 0.25 | 1:4 | 49 | 1 | 48 |
| | Zoxamid | 1 | | | | |

2. Activity Against Sclerotinia sclerotiorum in the Microtiterplate Test (SCLESC)
1. The stock solutions were mixed according to the ratio, pipetted onto a micro titer plate (MTP) and diluted with water to the stated concentrations. A spore suspension of Sclerotinia sclerotiorum in an aqueous biomalt or yeast-bactopeptone-sodiumacetate solution was then added. The plates were placed in a water vapor-saturated chamber at a temperature of 18° C. Using an absorption photometer, the MTPs were measured at 405 nm 7 days after the inoculation.

### Sclesc

| | Active | Concentration | | | Calculated | |
|---|---|---|---|---|---|---|
| | compound/ | (ppm) | | | efficacy | |
| Compound | active | weight/ | | Observed | according to | Synergism |
| Group | mixture | weight | Mixture | efficacy | Colby (%) | (%) |
| | Fusaricidin | 1 | — | 16 | | |
| | | 0.25 | — | 2 | | |
| 1 | Dithianon | 1 | — | 57 | | |
| 2 | Mandipropamid | 63 | — | 29 | | |
| 3 | Trifloxystrobin | 0.063 | — | 41 | | |
| 2 | Zoxamid | 1 | — | 0 | | |
| 1 | Fusaricidin | 1 | 1:1 | 100 | 64 | 36 |
| | Dithianon | 1 | | | | |
| 1 | Fusaricidin | 0.25 | 1:4 | 96 | 58 | 38 |
| | Dithianon | 1 | | | | |
| 2 | Fusaricidin | 1 | 1:63 | 68 | 41 | 27 |
| | Mandipropamid | 63 | | | | |
| 3 | Fusaricidin | 1 | 16:1 | 86 | 50 | 36 |
| | Trifloxystrobin | 0.063 | | | | |
| 2 | Fusaricidin | 1 | 1:1 | 90 | 16 | 74 |
| | Zoxamid | 1 | | | | |
| 2 | Fusaricidin | 0.25 | 1:4 | 39 | 2 | 37 |
| | Zoxamid | 1 | | | | |

3. Activity Against Grey Mold Botrytis cinerea in the Microtiterplate Test (BOTRCI)
1. The stock solutions were mixed according to the ratio, pipetted onto a micro titer plate (MTP) and diluted with water to the stated concentrations. A spore suspension of Botrci cinerea in an aqueous biomalt or yeast-bactopeptone-sodiumacetate solution was then added. The plates were placed in a water vapor-saturated chamber at a temperature of 18° C. Using an absorption photometer, the MTPs were measured at 405 nm 7 days after the inoculation.

### BOTRCI

| | Active | Concentration | | | Calculated | |
|---|---|---|---|---|---|---|
| | compound/ | (ppm) | | | efficacy | |
| Compound | active | weight/ | | Observed | according to | Synergism |
| Group | mixture | weight | Mixture | efficacy | Colby (%) | (%) |
| | Fusaricidin | 1 | — | 0 | | |
| | | 0.25 | — | 0 | | |
| 2 | Mandipropamid | 63 | — | 16 | | |
| 2 | Oxathiapiprolin | 16 | — | 11 | | |
| 3 | Pyriofenon | 16 | — | 12 | | |
| 3 | Trifloxystrobin | 0.063 | — | 0 | | |
| 2 | Zoxamid | 1 | — | 11 | | |
| 2 | Fusaricidin | 1 | 1:63 | 41 | 16 | 25 |
| | Mandipropamid | 63 | | | | |
| 2 | Fusaricidin | 1 | 1:16 | 29 | 11 | 18 |
| | Oxathiapiprolin | 16 | | | | |
| 3 | Fusaricidin | 1 | 1:16 | 35 | 12 | 23 |
| | Pyriofenon | 16 | | | | |
| 3 | Fusaricidin | 1 | 16:1 | 52 | 0 | 52 |
| | Trifloxystrobin | 0.063 | | | | |
| 2 | Fusaricidin | 0.25 | 1:4 | 50 | 11 | 39 |
| | Zoxamid | 1 | | | | |
| 2 | Fusaricidin | 1 | 1:1 | 51 | 11 | 40 |
| | Zoxamid | 1 | | | | |

4. Activity Against Rice Blast Pyricularia oryzae in the Microtiterplate Test (PYRIOR)
1. The stock solutions were mixed according to the ratio, pipetted onto a micro titer plate (MTP) and diluted with water to the stated concentrations. A spore suspension of Pyricularia oryzae in an aqueous biomalt or yeast-bactopeptone-glycerine or DOB solution was then added. The plates were placed in a water vapor-saturated chamber at a temperature of 18° C. Using an absorption photometer, the MTPs were measured at 405 nm 7 days after the inoculation.

### PYRIOR

| | Active | Concentration | | | Calculated | |
|---|---|---|---|---|---|---|
| | compound/ | (ppm) | | | efficacy | |
| Compound | active | weight/ | | Observed | according to | Synergism |
| Group | mixture | weight | Mixture | efficacy | Colby (%) | (%) |
| | Fusaricidin | 4 | — | 55 | | |
| | | 1 | — | 2 | | |
| 1 | Ametoctradin | 4 | — | 12 | | |
| 1 | Amisulbrom | 4 | — | 11 | | |
| | | 1 | — | 3 | | |
| 2 | Benthiavali- | 16 | — | 8 | | |
| | carb | 4 | — | 0 | | |
| 3 | Boscalid | 1 | — | 5 | | |
| 1 | Cyazofamid | 1 | — | 16 | | |
| | | 0.25 | — | 6 | | |
| 2 | Cymoxanil | 63 | — | 11 | | |
| | | 16 | | 3 | | |
| 1 | Fluazinam | 0.063 | — | 8 | | |
| 1 | Fluopicolid | 1 | — | 2 | | |
| 3 | Fluoxastrobin | 0.016 | — | 8 | | |
| 1 | Fluxapyroxad | 0.016 | — | 3 | | |
| 1 | Fosetyl-al | 4 | — | 4 | | |
| 2 | Iprovalicarb | 4 | — | 17 | | |
| | | 1 | — | 8 | | |
| 3 | Mancozeb | 0.25 | — | 5 | | |
| 2 | Mandipropamid | 16 | — | 7 | | |
| 1 | Methyltetraprol | 0.016 | — | 16 | | |
| 1 | Metiram | 16 | — | 17 | | |
| 3 | Metrafenon | 0.25 | — | 3 | | |
| 3 | Pyriofenon | 16 | — | 18 | | |
| | | 4 | — | 6 | | |
| 3 | Spiroxamin | 16 | — | 17 | | |
| | | 4 | — | 3 | | |
| 2 | Valifenalat | 4 | — | 1 | | |
| 2 | Zoxamid | 4 | — | 39 | | |
| 1 | Fusaricidin | 4 | 4:4 | 79 | 56 | 23 |
| | Ametoctradin | 4 | | | | |
| 1 | Fusaricidin | 4 | 4:4 | 100 | 60 | 40 |
| | Amisulbrom | 4 | 4:4 | | | |
| 1 | Fusaricidin | 4 | 4:1 | 84 | 56 | 28 |
| | Amisulbrom | 1 | | | | |
| 2 | Fusaricidin | 4 | 1:4 | 93 | 58 | 35 |
| | Benthiavalicarb | 16 | | | | |
| 2 | Fusaricidin | 1 | 1:16 | 49 | 10 | 39 |
| | Benthiavalicarb | 16 | | | | |
| 2 | Fusaricidin | 4 | 1:1 | 77 | 56 | 21 |
| | Benthiavalicarb | 4 | | | | |
| 3 | Fusaricidin | 4 | 4:1 | 76 | 57 | 19 |
| | Boscalid | 1 | | | | |
| 1 | Fusaricidin | 4 | 4:1 | 90 | 62 | 28 |
| | Cyazofamid | 1 | | | | |
| 1 | Fusaricidin | 4 | 16:1 | 97 | 57 | 40 |
| | Cyazofamid | 0.25 | | | | |
| 2 | Fusaricidin | 4 | 1:16 | 82 | 60 | 22 |
| | Cymoxanil | 63 | | | | |
| 2 | Fusaricidin | 4 | 1:4 | 78 | 56 | 22 |
| | Cymoxanil | 16 | | | | |
| 1 | Fusaricidin | 4 | 1:1 | 80 | 57 | 23 |
| | Fosetyl-al | 4 | | | | |
| 1 | Fusaricidin | 4 | 63:1 | 93 | 58 | 35 |
| | Fluaziman | 0.063 | | | | |
| 1 | Fusaricidin | 4 | 4:1 | 85 | 56 | 29 |
| | Fluopicolid | 1 | | | | |
| 3 | Fusaricidin | 1 | 63:1 | 35 | 10 | 25 |
| | Fluoxastrobin | 0.016 | | | | |
| 3 | Fusaricidin | 4 | 250:1 | 90 | 58 | 32 |
| | Fluoxastrobin | 0.016 | | | | |
| 1 | Fusaricidin | 4 | 250:1 | 78 | 56 | 22 |
| | Fluxapyroxad | 0.016 | | | | |
| 2 | Fusaricidin | 4 | 1:1 | 83 | 62 | 21 |
| | Iprovalicarb | 4 | | | | |
| 2 | Fusaricidin | 4 | 4:1 | 79 | 58 | 21 |
| | Iprovalicarb | 1 | | | | |
| 3 | Fusaricidin | 4 | 16:1 | 77 | 57 | 20 |
| | Mancozeb | 0.25 | | | | |
| 2 | Fusaricidin | 4 | 1:4 | 95 | 58 | 37 |
| | Mandipropamid | 16 | | | | |
| 1 | Fusaricidin | 4 | 1:4 | 82 | 62 | 20 |
| | Metiram | 16 | | | | |
| 1 | Fusaricidin | 1 | 63:1 | 44 | 18 | 26 |
| | Methyltetraprol | 0.016 | | | | |
| 1 | Fusaricidin | 4 | 250:1 | 92 | 62 | 30 |
| | Methyltetraprol | 0.016 | | | | |
| 3 | Fusaricidin | 4 | 16:1 | 88 | 56 | 32 |
| | Metrafenon | 0.25 | | | | |
| 3 | Fusaricidin | 4 | 1:4 | 100 | 63 | 37 |
| | Pyriofenon | 16 | | | | |
| 3 | Fusaricidin | 4 | 1:1 | 93 | 57 | 36 |
| | Pyriofenon | 4 | | | | |
| 3 | Fusaricidin | 4 | 1:4 | 96 | 62 | 34 |
| | Spiroxamin | 16 | | | | |
| 3 | Fusaricidin | 4 | 1:1 | 86 | 56 | 30 |
| | Spiroxamin | 4 | | | | |
| 3 | Fusaricidin | 1 | 1:16 | 55 | 19 | 36 |
| | Spiroxamin | 16 | | | | |
| 2 | Fusaricidin | 4 | 1:1 | 77 | 55 | 22 |
| | Valifenalat | 4 | | | | |
| 2 | Fusaricidin | 4 | 1:1 | 91 | 72 | 19 |
| | Zoxamid | 4 | | | | |

1. A mixture, comprising as active components
as component 1
a combination of fusaricidin A and fusaricidin B, wherein fusaricidin A and fusaricidin B have the general formula 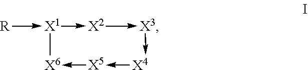
wherein
R is selected from 15-guanidino-3-hydroxypentadecanoic acid (GHPD) and 12-guanidinododecanoic acid (12-GDA);
X¹ is threonine;
X² is valine;
X³ is valine;
X⁴ is threonine;
X⁵ is selected from glutamine and asparagine;
X⁶ is alanine; and
wherein an arrow defines a single (amide) bond either between the carbonyl moiety of R and the amino group of the amino acid X¹ or between the carbonyl group of one amino acid and the amino group of a neighboring amino acid, wherein the tip of the arrow indicates the attachment to the amino group of said amino acid X¹ or of said neighboring amino acid; and
wherein a single line without an arrow head defines a single (ester) bond between the carbonyl group of X⁶ and the hydroxyl group of X¹ and
fusaricidin A has asparagine as X⁵ and
fusaricidin B has glutamine as X⁵, and
as component 2 a fungicide selected from the group consisting of:
difenoconazole, spiroxamine, fluxapyroxad, boscalid, fluindapyr, isoflucypram, inpyrfluxam, pydiflumetofen, pyrimethanil, fluoxastrobin, metyltetraprole, trifloxystrobin, cyazofamid, amisulbrom, zoxamide, cymoxanil, fluazinam, valifenalate, benthiavalicarb, iprovalicarb, man-dipropamid, dimethomorph, fluopicolide, ametoctradin, oxathiapiprolin, pyriofenone, metrafenone, metiram, mancozeb, dithianon, fosetyl or fosetyl-Al;
and wherein the mixture of component 1 and component 2 provides a synergistic fungicidal effect.

2. The mixture as claimed in claim 1, wherein the combination of fusaricidin A and fusaricidin B has a ratio of fusaricidin A to fusaricidin B between 10:1 to 1:10.

3. The mixture as claimed in claim 1, comprising cells or spores of one or more Paenibacillus strains still producing or having produced the fusaricidin A and fusaricidin B.

4. The mixture as claimed in claim 3, wherein said at least one Paenibacillus strain has antifungal activity against at least one species of phytopathogenic fungi from the genus Alternaria, Botrytis, Venturia, Leptosphaeria, Fusarium, Rhizoctonia, Phytophthora, Pythium, Colletotrichum, Pyricularia, Sclerotinia and Zymoseptoria.

5. The mixture as claimed in claim 1, further comprising at least one of the following compounds:

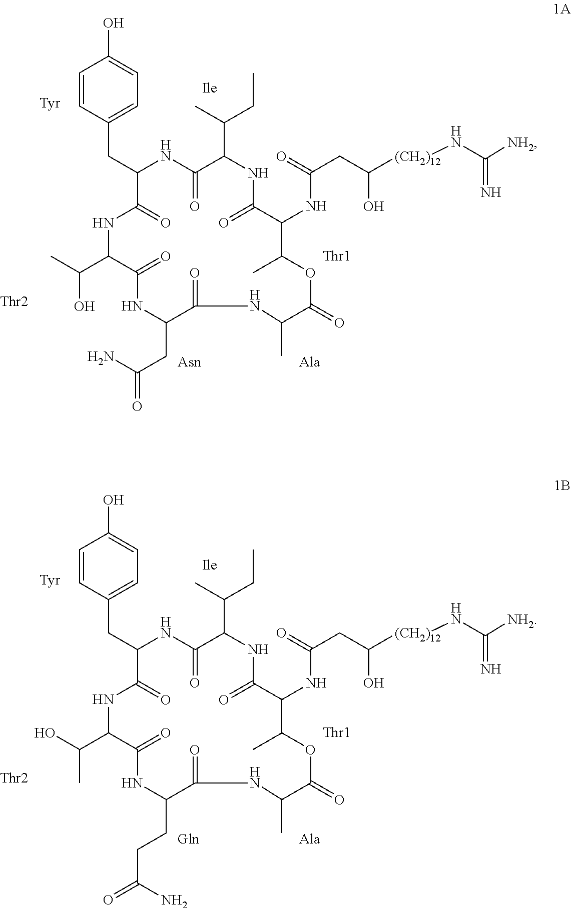

6. The mixture as claimed in claim 1, further comprising a paeniserin or a paeniprolixin.

7. The mixture as claimed in claim 1, comprising a further fungicide as component 3, wherein the fungicide of component 2 and the fungicide of component 3 are not identical.

8. The mixture as claimed in claim 1, comprising at least one further fungicide as component 3, selected from the following groups a) to m):
a) difenoconazole, prothioconazol, mefentrifluconazol, metconazole, triticonazol, difenoconazol, iriadimenol, prochloraz, tebuconazol, epoxiconazol, ipconazol, metalaxyl-M, mefenoxam, spiroxamine, penflufen, isofetamid, bixafen, fluxapyroxad, boscalid, benzovindiflupyr, fluopyram, penthiopyrad, sedaxan, fluindapyr, isoflucypram, inpyrfluxam, pydiflumetofen, cyprodinil, pyrimethanil, fluoxastrobin, azoxystrobin, trifloxystrobin, yraclostrobin, metyltetraprole, dimoxystrobin, picarbutrazox, fludioxonil, thiophanate, thiophanate-methyl, thiabendazol, silthiofam, picoxystrobin, orysastrobin, fenhexamid, fenpyrazamine, cyazofamid, amisulbrom, zoxamide, ethaboxam, cymoxanil, propamocarb, fluazinam, triazoxide, valifenalate, benthiavalicarb, iprovalicarb, mandipropamid, dimethomorph, fluopicolide, ametoctradin, oxathiapiprolin, fluoxapiprolin, pyriofenone, metrafenone, sulphur, metiram, mancozeb, thiram, folpet, dithianon, fosetyl and fosetyl-Al, preferably from difenoconazole, prothioconazol, mefentrifluconazol, metconazole, triticonazol, difenoconazol, triadimenol, prochloraz, tebuconazol, epoxiconazol, ipconazol, metalaxyl-M, mefenoxam, spiroxamine, fludioxonil, penflufen, bixafen, fluxapyroxad, boscalid, benzovindiflupyr, fluopyram, penthiopyrad, sedaxan, pyrimethanil, fluoxastrobin, metyltetraprole, azoxystrobin, trifloxystrobin, pyraclostrobin, dimoxystrobin, picoxystrobin, orysastrobin, cyazofamid, amisulbrom, thiabendazole, thiophanate-methyl, zoxamide, ethaboxam, cymoxanil, picarbutrazox, fluazinam, valifenalate, benthiavalicarb, iprovalicarb, mandipropamid, dimethomorph, fluopicolide, ametoctradin, silthiofam oxathiapiprolin, pyriofenone, metrafenone, metiram, mancozeb, thiram, dithianon, fosetyl or fosetyl-aluminium, more preferred from difenoconazole, prothioconazole, mefentrifluconazole, metconazole, triticonazole, difenoconazole, triadimenole, prochloraz, tebuconazole, epoxiconazole, ipconazole, metalaxyl-M, penflufene, bixafene, fluxapyroxad, benzovindiflupyr, fluopyram, penthiopyrad, sedaxane, pyrimethanil, azoxystrobin, trifloxystrobin, pyraclostrobin, dimoxystrobin, picoxystrobin, orysastrobin, ethaboxam, dimethomorph, thiram, picarbutrazox, fludioxonil, thiophanate, hiophanate-methyl, thiabendazole and silthiofam;
b) azoxystrobin, coumethoxystrobin, coumoxystrobin, dimoxystrobin, enestroburin, fenaminstrobin, fenoxystrobin/flufenoxystrobin, fluoxastrobin, metyltetraprole, kresoxim-methyl, mandestrobin, metominostrobin, orysastrobin, picoxystrobin, pyraclostrobin, pyrametostrobin, pyraoxystrobin, trifloxystrobin, 2 (2-(3-(2,6-dichlorophenyl)-1-methyl-allylideneaminooxymethyl)-phenyl)-2 methoxyimino-N methyl-acetamide, pyribencarb, triclopyricarb/chlorodincarb, famoxadone, fenamidone, methyl-N-[2-[(1,4-dimethyl-5 phenyl-pyrazol-3-yl)oxylmethyl]phenyl]-N-methoxy-carbamate, metyltetraprole, (Z,2E) 5 [1-(2,4-dichloro-phenyl)pyrazol-3-yl]-oxy-2-methoxyimino-N,3-dimethyl-pent-3-en-amide, (Z,2E) 5 [1 (4-chlorophenyl)pyrazol-3-yl]oxy-2-methoxyimino-N,3 dimethyl-pent-3-enamide, pyriminostrobin, bifujunzhi, 2-(ortho-((2,5-dimethylphenyl-oxy-methylen)phenyl)-3-methoxy-acrylic acid methylester, preferably from azoxystrobin, dimoxystrobin, fluoxastrobin, metyltetraprole, orysastrobin, picoxystrobin, pyraclostrobin, trifloxystrobin and metyltetraprole;
c) cyazofamid, amisulbrom, [(6S,7R,8R) 8 benzyl-3-[(3-hydroxy-4-methoxy-pyridine-2-carbonyl)amino]-6-methyl-4,9-dioxo-1,5-dioxonan-7-yl] 2-methylpropanoate, fenpicoxamid, florylpicoxamid, preferably from cyazofamid, amisulbrom and fenpicoxamid, more preferred from cyazofamid and amisulbrom;
d) benodanil, benzovindiflupyr, bixafen, boscalid, carboxin, fenfuram, fluopyram, flutolanil, fluxapyroxad, furametpyr, isofetamid, isopyrazam, mepronil, oxycarboxin, penflufen, penthiopyrad, pydiflumetofen, pyraziflumid, sedaxane, tecloftalam, thifluzamide, inpyrfluxam, pyrapropoyne, fluindapyr, N-[2-[2-chloro-4-(trifluoro-methyl)phenoxy]phenyl]-3-(difluoromethyl)-5-fluoro-1-methyl-pyrazole-4-carboxamide, methyl (E)-2-[2-[(5-cyano-2-methyl-phenoxy)methyl]phenyl]-3-methoxy-prop-2 enoate, isoflucypram, 2-(difluoromethyl)-N-(1,1,3-trimethyl-indan-4 yl)-pyridine-3-carboxamide, 2-(difluoromethyl)-N-[(3R)-1,1,3-trimethylindan-4-yl]-pyridine-3-carboxamide, 2-(difluoromethyl)-N-(3-ethyl-1,1-dimethyl-indan-4-yl)¬pyridine-3-carboxamide, 2-(difluoromethyl)-N-[(3R)-3-ethyl-1,1-dimethyl-indan-4-yl]-pyridine-3-carboxamide, 2-(difluoromethyl)-N-(1,1-dimethyl-3-propyl-indan-4-yl)-pyridine-3-carboxamide, 2-(difluoromethyl)-N-[(3R)-1 ,1 -dimethyl-3-propyl-indan-4-yl]¬pyridine-3-carboxamide, 2-(difluoromethyl)-N-(3-isobutyl-1,1-dimethyl-indan-4-yl)¬pyridine-3-carboxamide, 2-(difluoromethyl)-N-[(3R)-3-isobutyl-1,1-dimethyl-indan-4 yl]pyridine-3-carboxamide,
preferably from benzovindiflupyr, bixafen, boscalid, fluopyram, fluxapyroxad, isofetamid, penflufen, penthiopyrad, pydiflumetofen, sedaxane, inpyrfluxam, fluindapyr, isoflucypram,
more preferred from, benzovindiflupyr, bixafen, boscalid, fluopyram, fluxapyroxad, penflufen, penthiopyrad, sedaxane;
e) fluazinam, ametoctradin, silthiofam, spiroxamine, fludioxonil, fenhexamid, metalaxyl, metalaxyl-M, dithianon, preferably from fluazinam, ametoctradin, silthiofam, spiroxamine, fludioxonil, metalaxyl, metalaxyl-M and dithianon; more preferred fluazinam, ametoctradin, silthiofam, spiroxamine, metalaxyl, metalaxyl-M and dithianon f) azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazole, penconazole, propiconazole, prothio-iconazole, simeconazole, tebuconazole, tetraconazole, triadimefon, triadimenol, triticonazole, uniconazole, 2 (2,4-difluorophenyl)-1,1-difluoro-3-(tetrazol-1-yl)-1-[5-[4-(2,2,2-trifluoroethoxy)phenyl]-2 pyridyl]propan-2-ol, 2-(2,4-difluorophenyl)-1,1-difluoro-3-(tetrazol-1-yl)-1 [5 [4 (tri-ifluoromethoxy)phenyl]-2-pyridyl]propan-2-ol, 4-[[6-[2-(2,4-difluorophenyl)-1,1-difluo¬ro-2-hydroxy-3-(5-sulfanyl-1,2,4-triazol-1-yl)propyl]-3-pyridyl]oxy]benzonitrile, ipfen¬itrifluconazole, mefentrifluconazole, (2R)-2-[4-(4-chlorophen-oxy)-2-(trifluoromethyl)phenyl]-1-(1,2,4-triazol-1-yl)propan-2-ol, (2S)-2-[4-(4-chlorophenoxy)-2-(trifluoromethyl)phenyl]-1-(1,2,4-triazol-1-yl)propan-2-ol, 2-(chloromethyl)-2-methyl-5-(p-tolyl¬methyl)-1 (1,2,4-triazol-1 ylmethyl)cyclopentanol; imidazoles: imazalil, pefurazoate, prochloraz, triflumizol, pyrimidines, pyridines, piperazines: fenarimol, pyrifenox, triforine, [3-(4-chloro-2-fluoro-phenyl)-5-(2,4-di¬fluoro-phenyl)isoxazol-4-yl]-(3-pyridyl)methanol, 4-[[6-[2-(2,4-difluorophenyl)-1,1-di¬flu¬oro-2-hydroxy-3-(1 ,2,4-triazol-1-yl)propyl]-3-pyridyl]oxy]¬benzo¬nitrile, 2-[6-(4-bro¬mo-phenoxy)-2-(trifluoromethyl)-3-pyridyl]-1-(1,2,4-triazol-1 yl)propan-2-ol, 2-[6-(4-chlo-rophenoxy)-2-(trifluoromethyl)-3-pyridyl]-1-(1,2,4-triazol-1-yl)propan-2-ol,
preferably from difenoconazole, epoxiconazole, ipconazole, metconazole, prothioconazole, tebuconazole, triadimenol, triticonazole and prochloraz;
g) thiabendazole, thiophanate-methyl, diethofencarb, ethaboxam, pencycuron, fluopicolide, zoxamide, metrafenone and pyriofenone, preferably from thiabendazole, thiophanate-methyl, ethaboxam, fluopicolide, zoxamide, metrafenone, pyriofenone, more preferred from ethaboxam, fluopicolide, zoxamide, metrafenone, pyriofenone;
h) cyprodinil, mepanipyrim, pyrimethanil, preferably pyrimethanil;
i) dimethomorph, flumorph, mandipropamid, pyrimorph, benthiavalicarb, iprovalicarb, valifenalate, preferably from dimethomorph, mandipropamid, benthiavalicarb, iprovalicarb, valifenalate;
oxathiapiprolin, fluoxapiprolin, 4 [1 [2 [3-(difluoromethyl)-5-methyl-pyrazol-1-yl]acetyl]-4-piperidyl]-N-te¬tralin-1-yl-pyridine-2 carboxamide, 4-[1-[2-[3,5-bis(difluoromethyl)pyrazol-1-yl]acetyl]-4-piperidyl]-N-tetralin-1-yl-pyridine-2-carboxamide, 4-[1 -[2-[3-(difluoromethyl)-5-(trifluoromethyl)pyrazol-1-yl]acetyl]-4-piperidyl]-N- tetralin-1-yl-pyridine-2-carboxamide, 4-[1-[2-[5-cyclopropyl-3-(difluoromethyl)pyrazol-1-yl]acetyl]-4-piperidyl]-N-tetralin-1-yl-pyridine-2-carboxamide, 4-[1-[2-[5-methyl-3-(trifluoromethyl)pyrazol-1-yl]acetyl]-4-piperidyl]-N-tetralin-1-yl-pyridine-2-carboxamide, 4-[1-[2-[5-(difluoromethyl)-3-(trifluoro-methyl)pyrazol-1yl]acetyl]-4-piperidyl]-N-tetralin-1-yl-pyridine-2-carboxamide, 4 [1 [2-[3,5-bis(trifluoromethyl)pyrazol-1-yl]acetyl]-4-piperidyl]-N-tetralin-1-yl-pyridine-2-car¬boxamide, (4 [1-[2-[5-cyclopropyl-3-(trifluoromethyl)pyrazol-1-yl]acetyl]-4-piperidyl]-N-tetralin-1-yl-pyridine-2-carboxamide,
preferably from oxathiapiprolin and fluoxapiprolin,
more preferred is oxathiapiprolin;
k) ferbam, mancozeb, maneb, metam, metiram, propineb, thiram, zineb, ziram, preferably from mancozeb, metiram and thiram;
l) fosetyl, fosetyl-aluminum, phosphorous acid and its salts, calcium phosphonate, potassium phosphonate, preferably from fosetyl and fosetyl-aluminum;
m) cymoxanil, fenpyrazamine, triazoxide, picarbutrazox, preferred is cymoxanil,
wherein the fungicide of component 2 and the fungicide of component 3 are not identical.

9. The mixture as claimed in claim 1, wherein component 3 is difenoconazole, prothioconazol, mefentrifluconazol, metconazole, triticonazol, difenoconazol, triadimenol, prochloraz, tebuconazol, epoxiconazol, ipconazol, metalaxyl-M, mefenoxam, spiroxamine, penflufen, bixafen, fluxapyroxad, boscalid, benzovindiflupyr, fluopyram, penthiopyrad, sedaxan, pyrimethanil, fluoxastrobin, metyltetraprole, azoxystrobin, trifloxystrobin, pyraclostrobin, dimoxystrobin, picoxystrobin, orysastrobin, cyazofamid, amisulbrom, thiabendazole, thiophanate-methyl, zoxamide, ethaboxam, cymoxanil, picarbutrazox, fluazinam, valifenalate, benthiavalicarb, iprovalicarb, mandipropamid, dimethomorph, fluopicolide, ametoctradin, silthiofam, oxathiapiprolin, pyriofenone, metrafenone, metiram, mancozeb, thiram, dithianon, fosetyl, or fosetyl-aluminium, wherein the fungicide of component 2 and the fungicide of component 3 are not identical.

10. The mixture as claimed in claim 1, wherein component 2 is boscalid, trifloxystrobin, zoxamide, cymoxanil, mandipropamid, iprovalicarb, fluopicolide, ametoctradin, oxathiapiprolin, metiram, mancozeb, dithianon, fosetyl, or fosetyl-aluminium.

11. A mixture as claimed in claim 7, wherein
component 2 is spiroxamine and component 3 is fluopyram, or
component 2 is boscalid and component 3 is pyraclostrobin, or
component 2 is pyrimethanil and component 3 is dithianon or trifloxystrobin, or
component 2 is trifloxystrobin and component 3 is pyrimethanil or fluopyram; or
component 2 is zoxamide and component 3 is mandipropamid, oxathiapiprolin, or mancozeb; or
component 2 is cymoxanil and component 3 is mandipropamid; or
component 2 is mandipropamid and component 3 is difenoconazole, cymoxanil, azoxystrobin, or zooxamide; or
component 2 is fluopicolide and component 3 is fosetyl-aluminium; or
component 2 is ametoctradin and component 3 is dimethomorph; or
component 2 is oxathiapiprolin and component 3 is zoxamide; or
component 2 is mancozeb and component 3 zoxamide, metalayl, metalaxyl-M, or dimethomorph; or
component 2 is dithianon and component 3 is pyrimethanil or dimethomorph; or
component 2 is fosetyl or fosetyl aluminium and component 3 is fluopyram or fluopicolide.

12. An agrochemical composition comprising a mixture as defined in claim 1 and an auxiliary.

13. A plant propagation material having a coating comprising a mixture as defined in claim 1.

14. (canceled)

15. A method of suppressing or preventing fungal infection, wherein the fungi, their habitat or the materials or plants to be protected against fungal attack, or the soil or plant propagation material are treated with an effective amount of a mixture as defined in claim 1.

16. A method for suppressing or preventing fungal infection of plants, wherein plants, parts of plants or the soil close to the plant is treated with a mixture as claimed in claim 1 and the mixture is applied to the plants, parts of plants or the soil close to the plant in a form wherein component 2 is applied to the plants
a) in a mixture as claimed in claim 1, or
b) not more than ten days before application of component 1, or
c) not more than five days after the application of component 1, or
d) on the same day as the application of component 1.

17. The method for suppressing or preventing fungal infection of plants as claimed in claim 16, wherein component 2 is difenoconazole, prothioconazol, mefentrifluconazol, metconazole, triticonazol, difenoconazol, triadimenol, prochloraz, tebuconazol, epoxiconazol, ipconazol, metalaxyl-M, mefenoxam, spiroxamine, fludioxonil, penflufen, bixafen, fluxapyroxad, boscalid, benzovindiflupyr, fluopyram, penthiopyrad, sedaxan, fluoxastrobin, metyltetraprole, azoxystrobin, trifloxystrobin, pyraclostrobin, dimoxystrobin, picoxystrobin, orysastrobin, cyazofamid, amisulbrom, thiabendazole, thiophanate-methyl, zoxamide, ethaboxam, cymoxanil, picarbutrazox, fluazinam, valifenalate, benthiavalicarb, iprovalicarb, mandipropamid, dimethomorph, fluopicolide, ametoctradin, silthiofam oxathiapiprolin, pyriofenone, metrafenone, metiram, mancozeb, thiram, dithianon, fosetyl, or fosetyl-aluminium.

18. The method for suppressing or preventing fungal infection of plants as claimed in claim 16, wherein the mixture comprises a fungicide as component 3 and the fungicide of component 2 and component 3 are not identical.

19. The method for suppressing or preventing fungal infection as claimed in claim 18, wherein
a) component 2 is spiroxamine and component 3 is fluopyram, or
b) component 2 is boscalid and component 3 is pyraclostrobin, or
c) component 2 is pyrimethanil and component 3 is dithianon and/or trifloxystrobin; or
d) component 2 is zoxamide and component 3 mandipropamid, oxathiapiprolin, or mancozeb; or
e) component 2 is cymoxanil and component 3 is mandipropamid; or
f) mandipropamid and component 3 is difenoconazole, cymoxanil, azoxystrobin, and/or zooxamide; or
g) component 2 is fluopicolide and component 3 is fosetyl-aluminium; or
h) component 2 is ametoctradin and component 3 is dimethomorph; or
i) component 2 is oxathiapiprolin and component 3 is zoxamide; or
j) component 2 is mancozeb and component 3 is zoxamide, metalaxyl, metalaxyl-M, or dimethomorph; or
k) component 2 is dithianon and component 3 is pyrimethanil, or dimethomorph; or
l) component 2 is fosetyl or fosetyl aluminium and component 3 fluopyram or fluopicolide.

20. The method for suppressing or preventing fungal infection as claimed in claim 15, wherein the mixture of fusaricidin A and fusaricidin B is provided by a Paenibacillus strain.

21. The method for suppressing or preventing fungal infection as claimed in claim 15, wherein component 2 is bixafene, fluoxastrobine, trifloxystrobine, metyltetraprole, cyazofamide, amisulbrome, fluaziname, iprovalicarbe, fluopicolide, metrafenone, or mancozeb and component 2 is applied in a mixture with component 1, or on the same day as the application of component 1, or is applied not more than ten days before application of component 1.

22. The method for suppressing or preventing fungal infection as claimed in claim 15, wherein component 2 is spiroxamine, cymoxanile, benthiavalicarbe, oxathiapiproline, pyriofenone, metrafenone, zoxamide, metiram, boscalid, valifenalate, ametoctradin, dithianon, fosetyl, fosetyl-Al, or mandipropamide and is applied in a mixture with component 1, or on the same day as the application of component 1, or is applied not more than five days before application of component 1.

23. The method for suppressing or preventing fungal infection of plants as claimed in claim 15, wherein the mixture of component 1, component 2, and, if applicable, component 3 is applied at least once between
a) growth stage 56 to 89 for fruit and nut trees, or
b) growth stage 56 to 85, for berry fruits, or
c) growth stage 61 to 89, for grape vine, or
d) growth stage 41 to 49, for head forming vegetables, or
e) growth stage 22 to 81, for cucurbits, or
f) growth stage 51 to 71, for solanaceous vegetables.
